(19) United States
(12) Patent Application Publication
(10) Pub. No.: US 2019/0024975 A1
(43) Pub. Date: Jan. 24, 2019

(54) COMPATIBLE ROOF RACK GARMENT EXSICCATION CONTAINER

(71) Applicant: Chad D McKinney, San Diego, CA (US)

(72) Inventor: Chad D McKinney, San Diego, CA (US)

(21) Appl. No.: 16/069,835

(22) PCT Filed: Jan. 20, 2017
(86) PCT No.: PCT/US17/14421

§ 371 Date: Jul. 12, 2018

Related U.S. Application Data
(60) Provisional application No. 62/281,120, filed on Jan. 20, 2016.

(51) Int. Cl. F26B 21/00; F26B 19/00; F26B 9/00

(52) U.S. Cl. CPC F26B 21/008; B01D 1/00; F26B 9/003; F26B 19/005

(57) ABSTRACT

This application relates to a system and methods for the exsiccation of material objects. The system can include a ventilation device. The material object can be attached to the ventilation device. The system can further include a container for the ventilation device and material object. The system can be attached and detached to a vehicle without the need for tools and can be compatible with preexisting vehicle roof racks.

### CROSS-REFERENCE TO RELATED APPLICATION

This application claims priority to U.S. Provisional Patent Application No. 62/281,120, filed Jan. 20, 2016; the entire disclosure thereof is incorporated herein by reference.

### FEDERALLY SPONSORED RESEARCH

None

### BACKGROUND

The invention described herein relates to systems and methods for the exsiccation of material objects. The system can include a ventilation device. The material object can be attached to the ventilation device. The system can further include a container for the ventilation device and material object. The system can be attached and detached to a vehicle without the need for tools and can be compatible with preexisting vehicle roof racks.

The following is a tabulation of some prior art that presently appears relevant:

U.S. Patents

| Patent Number | Kind Code | Issue Date | Patentee |
|---|---|---|---|
| 4,793,535 | A | 1988 Dec. 27 | Johnson |
| 8,141,268 | B2 | 2012 Mar. 27 | Vezina et al. |
| 6,386,414 | B1 | 2002 May 14 | Kilduff |

U.S. Patent Application Publications

| Publication Nr. | Kind Code | Publ. Date | Applicant |
|---|---|---|---|
| 2009-0308902 | A1 | 2009 Dec. 17 | Rex |
| 2014-0097219 | A1 | 2014 Apr. 10 | Reiber |
| 2013-0062300 | A1 | 2013 Mar. 14 | Drake |
| 2012-0291823 | A1 | 2012 Nov. 22 | Trent et al. |

Foreign Patent Documents

| Foreign | | | | App or |
|---|---|---|---|---|
| Doc. Nr. | Cntry Code | Kind Code | Pub. Dt | Patentee |
| 1759739 | EP | A2 | 2007 Mar. 07 | Cunningham |
| | | | | et al. |

Gear for water activities such as a wetsuit remaining wet after use presents several problems for the user, the garment, and its surrounding area. This can include: damage to the interior of the vehicle; damage to other materials stored in the vehicle and/or near the wetsuit; damage to one's home by the tracking of sand and/or water over rugs and floors, walls, etc., thereby increasing home repair expenditures and decreasing property value; an increase in potential microbial bacteria buildup in the wetsuit, vehicle interior, and/or home, therefore posing a greater threat to the user of said wetsuit of contracting an illness or disease; and discomfort of returning to a cold, damp and/or drenched wetsuit prior to re-entering the water.

Devices are known for the storage, transportation and drying of surfboards and all related equipment. For example, U.S. application Ser. No. 12/138,878 to Rex filed on Jun. 13, 2008 provides a container for storing, carrying or holding a surfboard and a minimal amount of related equipment on top of a vehicle and even using at least one air inlet aperture and one air exhaust aperture to dry the surfboard and said equipment. However, said container is bulky; more specifically designed for surfboards and does not provide a means to secure a wetsuit from movement for maximum drying efficiency. The device also requires hand tools and lacks a convenient and expedient means for the attachment and or removal of the container from a vehicle.

U.S. application Ser. No. 13/998,182 to Reiber on Oct. 9, 2013 provides another means for carrying and drying cargo, however, it is attached to the roof of the vehicle through a complicated rail system and intended to hold a multiple inventory of cargo. The system does provide a means to secure the material once it is placed inside the container however this system lacks expediency, versatility and adaptability with existing racks and requires hand tools to assemble and mount the container to the vehicle. It also requires the user to either be extremely tall, use a step ladder, or engage in an awkward and dangerous body posture to safely attach and detach the container from the complicated rail system that is now permanently mounted to the vehicle. This system further does not allow for the storage and transportation of surfboards on top of the vehicle due to its bulky and cumbersome shape and size.

U.S. Pat. No. 8,141,268 to Vezina and Lebel filed on Dec. 23, 2009 describes a flexible bag designed for the drying of sports equipment including, but not limited to, wetsuits. However, the ventilation design of this bag utilizes a blower mounted to the frame and sent into a tubular structure. This bag is further limited by its dependency on electricity to function as designed.

E.P. Pat. Publication Application No. EP1759739 A2 to BURTON CORPORATION published on Mar. 7, 2007 describes an adjustable snowboard binding. The ratchet strap system that is used to secure a snowboard boot inside a snowboard binding influenced one of the design mechanisms of compressing, locking and releasing the roof rack watersport garment exsiccation container. However, this is one of many design options available for accomplishing the compression, locking and releasing of the roof rack watersport garment exsiccation container and its stored garments.

There have been cargo carriers that resolve the problem of drying wetsuits, towels and other related material. However, these prior art inventions often require purchasing a large, bulky container that must either be permanently installed on top of a preexisting roof rack; require modification to the roof of the vehicle; are attached and released with hand tools; are expensive; aesthetically unpleasant to the appearance of the vehicle; and or incompatible with other roof racks and their intended use. The bulky nature of the prior art systems further serves as a detriment to the fuel efficiency and aerodynamics of the vehicle. Some of the prior art systems even require the vehicle operator to remove current pre-existing roof racks and replace and mount the system in its place. This requires tools, money, time, and a degree of mechanical aptitude. Once the large, bulky containers are secured to the vehicle and or preexisting roof rack they often times remain a permanent fixture upon the vehicle due to their time and tool restrictive methodology of attachment. Therefore, even if a person were to use the exsiccation systems of the prior art, the majority of individuals would require a ladder to secure and then remove the watersport garments inside of the container. Further, the prior art fails to provide a means for the air flow to travel through the material that is being exsiccated. The majority of the prior art related to cargo containers further limits the use of any preexisting roof rack to only objects that meet size and dimension restraints of that particular container. The incompatibility created by the prior art results in a loss of space and versatility with any preexisting roof rack and or cargo container. The oversized nature of the related prior art creates a great inconvenience and lack of plausibility for home, shed and or garage storage even if an individual were to have the equipment, resources, know-how, and then take the time to remove it from the roof of the vehicle.

### SUMMARY

The invention described herein relates to a roof rack garment exsiccation device that can provide a convenient, efficient and expedient means for drying water sport garments such as wetsuits by securely and easily attaching and detaching to the roof of a vehicle as to utilize the wind force generated by the motion of said vehicle as a means to exsiccate the material secured inside said container and to the aperture apparatuses. The invention can also be utilized to exsiccate other outdoor and/or snow sports gear, such as snow suits, snow bibs, jackets, boots and gloves used for ski or snowboarding. The roof rack garment exsiccation container can coexist with most preexisting surf and roof racks. The compact design can be convenient for storage of the container in the vehicle or home when not in use.

One embodiment of the invention includes a thin, aerodynamic system for the exsiccation of garments that is compatible with most preexisting vehicle roof racks and convenient and expedient to attach and detach from the roof of the vehicle without the need for hand tools or modification and or damage to the vehicle. The garments are placed flat and in any other appropriate manner inside the container and secured using a ratchet system (25c) once the lid (23) is closed. The container is then secured to the roof of the vehicle with straps (22) and a strap, buckle system (31). The force of the wind (21) generated by the movement of the vehicle exsiccates the material stored inside the container by flowing through the front and back aerated openings (26). The container is lightweight and compact and may be folded and stored inside the vehicle when not in use.

The roof rack garment exsiccation container can satisfy these objects and thus can facilitate the use of the improved method of supporting garments of the instant invention. The user can enjoy the benefits of an increased useful life of their garments given that they will be dry quickly and safely and in a manner that minimizing damage to the garment incurred when using other drying methods. Further there will be no need to place wet garments in the sun for lengthy periods of time to dry, thus reducing potential sun and weather damage to the garment. Sun drying is highly discouraged by sellers and manufacturers of wetsuits and other water and outdoor sports garments. The roof rack garment exsiccation container can reduce potential harmful bacterial colonization and infection to the garment being dried, its surrounding area where left soaking wet, and most importantly to the user.

The roof rack garment exsiccation container offers a novel solution to the major problems surrounding the care and drying of wet garments, such as watersport garments, snow sport garments and other similar garments, both at home and on the go.

Some embodiments of the invention relate to a system for exsiccation of a material object comprising a ventilation device, where the ventilation device comprises a front portion and a back portion. The front portion can include the front of an aerodynamic aperture. The back portion can include the back of the aerodynamic aperture and means to attach the material object. In some embodiments, air can travel through into the front portion, out the back portion and on to the material object when the material object is attached to the back portion and when the system is attached to a body in motion. The ventilation device can be one solid piece including a front and back portion. The device can be 2, 4, or more pieces.

Some embodiments of the invention relate to a system for exsiccation of a material object comprising a ventilation device, where the ventilation device comprises a front side and a back side. The front side can include the front of an aerodynamic aperture. The back side can include the back of the aerodynamic aperture and means to attach the material object. In some embodiments, air can travel through into the front side, out the back side and on to the material object when the material object is attached to the back side and when the system is attached to a body in motion. The ventilation device can be one solid piece including a front and back portion. The device can be 2, 4, or more pieces.

In some embodiments, the material object can be a watersport garment. For example, the material object can be a wetsuit.

In another embodiment, the material object can be other sports gear. For example, the material object can be snow sports gear, such as snow suits, snow bibs, jackets, boots and gloves used for ski or snowboarding.

In some embodiments, the back portion can include one or more additional openings for air to travel through to the material object when the material object is attached to the back portion and when the system is attached to a body in motion.

In some embodiments, the system can also include a container for the ventilation device and the material object. The container can be connected to the ventilation device.

In some embodiments, the back portion can include one or more additional openings for air to travel through and into the container when the container is attached to the ventilation device and when the system is attached to a body in motion. In some embodiments, the back portion can include hanger arms on the sides of the back portion. In some embodiments, the hanger arms can be hollow and can include one or more additional openings for air to travel through the hanger arms and on to the material object. In some embodiments, the back portion can be a hourglass shape. In some embodiments, the back portion can have a neck that is smaller in circumference than the aperture.

In some embodiments, the ventilation device can include a material selected from high-density polyethylene, polyethylene terephthalate, polyvinyl chloride, low-density polyethylene, polypropylene, polycarbonate, polylactide, any other plastic, nylon, composite, aluminum, or the like, and/or combinations thereof.

In some embodiments, the container can include one or more materials of mesh, micro fiber terry cloth, nylon ripstop, or the like, and/or combinations thereof.

In some embodiments, the system can be secured to the roof of a motor vehicle. In some embodiments, the system can be secured to the roof a motor vehicle by an attachment system comprising a strap, a buckle, a harness, or the like, and/or combinations thereof.

In some embodiments, the harness can be made of nylon webbing, polypropylene webbing, plastic, aluminum, composite, or the like, and/or combinations thereof.

In some embodiments, the container can have an opening for a strap that tunnels the width of the container. In an alternative embodiment, the opening does not tunnel the distance through the width of the container. For instance, the strap can be inserted and exit two slits on opposite ends of the width at various portions of the container making it adaptable to a two or four door vehicle.

In some embodiments, the opening for a strap includes a strap that can be attached to the roof of a motor vehicle.

In some embodiments, the container can have a container opening for accessing the inside of the container.

In some embodiments, the material object can be a garment with sleeves, wherein the garment can hang from the hanger arms.

In some embodiments, air can flow through the hanger arms and into the sleeves of the garment.

Some embodiments relate to a method of exsiccating a material object including attaching the material object to the system. attaching the system to a roof of a motor vehicle, moving the motor vehicle, where upon moving the motor vehicle, air flows through the ventilation device into the container to exsiccate the material object.

### Advantages

The invention described herein holds several advantages over the prior art. The roof rack garment exsiccation system can be designed to fit sleekly underneath, and between and/or over preexisting roof racks while transporting surfboards and or other sport accessories. It can be quickly and conveniently loaded, attached, secured and removed to and from the vehicle without the need for tools, modification and or fabrication to the vehicle. In some embodiments, the invention can secure safely and conveniently to most vehicles with adjustable straps and buckles, regardless of whether or not it harbors a preexisting roof rack. This can avoid damage and/or the need for modification to the interior or exterior of the vehicle or any preexisting roof rack. In some embodiments, the invention can be reconfigured easily and without tools to fit vehicles of various sizes and door configurations. In some embodiments, the invention can compress, secure and exsiccate single or multiple garments, such as wetsuits, towels, and/or swimsuits, snow suits, snow bibs, and/or jackets, and the like, utilizing the airflow generated from the movement of the vehicle into and through an aperture of the garment, such as the neck. Thus, the garments can be dry and warm for the next time in use. Apprehension and dread for returning to the water in a cold, drenched garments, such as water sport gear and snow gear, can be avoided. Now having an ability to quickly and effectively exsiccate garments can create greater satisfaction and enthusiasm for continuously participating in water and snow sports. In some embodiments, the invention can be compact and easily placed and secured in the vehicle while not in use. The invention can be sustainable and environmentally friendly utilizing free and readily available air flow generated by the motion of the vehicle to exsiccate the wet material storedand secured by the system. The aerodynamic design can allow the vehicle to operate with maximum fuel efficiency. The expedited exsiccation of the wetsuits, accessories, towels, swimsuits, snow bibs, jackets, and the like, can expand the use and lifespan of the material by preventing the buildup of microbial bacteria which is often harmful to the garmets and or users. This can further protect user health.

### BRIEF DESCRIPTION OF THE DRAWINGS

In the drawings, closely related figures have the same number but different alphabetic suffixes. It is understood that the figures are for illustration purposes. They are not to scale, and are not intended to limit the scope of the invention.

FIG. 1 depicts a side view of the front ventilation portion connected to the back ventilation portion.

FIG. 2 depicts a side view of the front ventilation portion disconnected from the back ventilation portion to illustrate how the components can be connected.

FIG. 3 depicts air flow through the ventilation device.

FIG. 4 depicts air flow through the ventilation device.

FIG. 5 depicts air flow through the system and garment.

FIG. 6 depicts a top view of the system containing a garment.

FIG. 7 depicts a top view of the system containing a garment on a vehicle.

FIGS. 8A depicts a passenger side view of an aerodynamically shaped container and a one strap system securing method to illustrate airflow into and through the system

FIG. 8B depicts a driver's side view of an aerodynamically shaped container and a strap system securing method to illustrate airflow into and through the system.

FIG. 8C depicts a top view of the ventilation device, container, garment, and one strap system securing method to illustrate to illustrate airflow into and through the system.

FIG. 8D depicts a front view of the ventilation device, container, and one strap system securing method.

FIG. 8E depicts a top view of the ventilation device, container, and one strap system securing method.

FIG. 9A depicts a passenger side view of an alternate aerodynamically shaped container and a one strap system securing method to illustrate airflow into and through the device.

FIG. 9B depicts a driver's side view of an alternate aerodynamically shaped container and a one strap system securing method to illustrate airflow into and through the device.

FIG. 9C depicts a top view of the ventilation device, alternate container, garment, and one strap system securing method to illustrate to illustrate airflow into and through the device.

FIG. 9D depicts a front view of the ventilation device, alternate container, and one strap system securing method.

FIG. 9E depicts a top view of the ventilation device, alternate container, and one strap system securing method.

FIG. 10A depicts a passenger side view of an aerodynamically shaped container and a two strap system securing method to illustrate airflow into and through the system.

FIG. 10B depicts a driver's side view of an aerodynamically shaped container and a two strap system securing method to illustrate airflow into and through the device.

FIG. 10C depicts a top view of the ventilation device, container, garment, and two strap system securing method to illustrate to illustrate airflow into and through the device.

FIG. 10D depicts a front view of the ventilation device, container, and two strap system securing method.

FIG. 10E depicts a top view of the ventilation device, container, and two strap system securing method.

FIG. 11A depicts a passenger side view of an alternative aerodynamically shaped container and a one strap system securing method to illustrate airflow into and through the device.

FIG. 11B depicts a driver's side view of an alternative aerodynamically shaped container and a one strap system securing method to illustrate airflow into and through the device.

FIG. 12A depicts a passenger side view of an alternative aerodynamically shaped container and a two strap system securing method to illustrate airflow into and through the device.

FIG. 12B depicts a driver's side view of an alternative aerodynamically shaped container and a two strap system securing method to illustrate airflow into and through the device.

FIG. 13 depicts a side front view of a various method of securing the system to a pre-existing roof rack of a vehicle.

FIG. 14 depicts a side view of a ratchet strap system to compress and secure container and its contents.

FIG. 15 depicts a side view of an alternative strap and buckle system to compress and secure container and its contents.

FIG. 16 depicts a side view of another alternative strap and buckle system to compress and secure container and its contents.

FIG. 17 depicts a side view of a strap, buckle, and harness system to secure container and its contents to roof of the vehicle from inside the vehicle.

FIG. 18 depicts a side view of another strap, buckle, and harness system to secure container and its contents to roof of the vehicle from inside the vehicle.

FIG. 19 depicts a side view of another strap, buckle, ratchet, and harness system to secure container and its contents to roof of the vehicle from inside the vehicle.

### DRAWINGS—REFERENCE NUMERALS

21 Airflow generated from wind and or vehicle movement
22 Straps to conveniently secure and remove container to and from vehicle
23 Container for garments
24 Opening for straps to slide completely through container
25 Hinges to permit opening and closing of container
25b Hinges to permit the compact folding and unfolding of container
25c Ratchet strap system to compress and secure container and its contents
26 Aerated opening
27 Garments located inside container
28 Side supporting wall of container
29 Bolt securing strap to side of container
29b Bolt securing belt and strap to top of container
30 Strap with raised ridges to tighten and secure in place with buckle system
31 Ratchet buckle pivot lock and release system
31b Buckle system secured to side of container for strap to be looped and tightened through to compress and secure container and its contents
31c Buckle, lock, tighten, and release system
31d Buckle system for straps to be looped and tightened through to secure container and its contents to roof of vehicle while parked and in motion
31e Buckle, lock, tighten, and release system to secure container and its contents to roof of vehicle while parked and in motion
32 Strap secured to exterior top of container and holding ratchet buckle pivot system in place
33 Preexisting roof rack
34 Container if made of malleable material wrapped around preexisting roof rack
35 Strap with loop and lock system to compress and secure container to preexisting roof rack
36 Latch system to further stabilize container and prevent opening while in use
37 Apparatus for securing aperture of garment to internal intake ventilation of container
38 Strap to secure garment to aperture of internal intake ventilation
39 Opening for container to be secured to and removed from ventilation device by screw and bolt
40 Opening for front ventilation and back ventilation and hanger pieces to be attached and secured by screw and bolt to form the ventilation device
41 Back ventilation and hanger portion of the ventilation device
42 Hanger arms of back ventilation device to attach, secure and exsiccate a garment
43 Aperture to allow air flow to travel and exsiccate through the hanger arms of ventilation device and into the shoulders and sleeves of garment
44 Rib structure for the strengthening and stabilization of the large aperture of the front portion of the ventilation device
45 Aerodynamic rim to the front ventilation device to allow for the attachment of the container to the ventilation device while remaining protected from the force of the wind
46 Large aerodynamic aperture to the front ventilation device to allow the force of the wind to travel into, through and around the ventilation device and into, through and around the garment attached to the ventilation device
47 Opening and closing to the top of the container that allows for maximum accessibility and security to the objects stored and exsiccated within
48 Opening to the legs of the ventilation device that allows for strap and buckle system to slide through and secure the container to the roof of the vehicle
49 Leg of the ventilation device to elevate and stabilize ventilation device to the roof of the vehicle
50 Rear portion to the back ventilation and hanger system opening and maximizing airflow into, through and around the garment
51 Vehicle
52 Elevated lip to the rear portion to the back ventilation and hanger system opening and maximizing airflow into, through and around the garment
53 Slight concave into the rear neck of the ventilation and hanger system forcing a portion of the airflow to return through the device and into and out the hanger arms into, through and around the garment
54 Neck to the front portion of the ventilation device allowing the back portion of the ventilation device to be attached to the front portion of the ventilation device while allowing air flow to travel from the front portion of the ventilation device into, through and around the back portion of the ventilation device
55 Ventilation device
56 Front portion of ventilation device
57 Back portion of ventilation device

### DETAILED DESCRIPTION

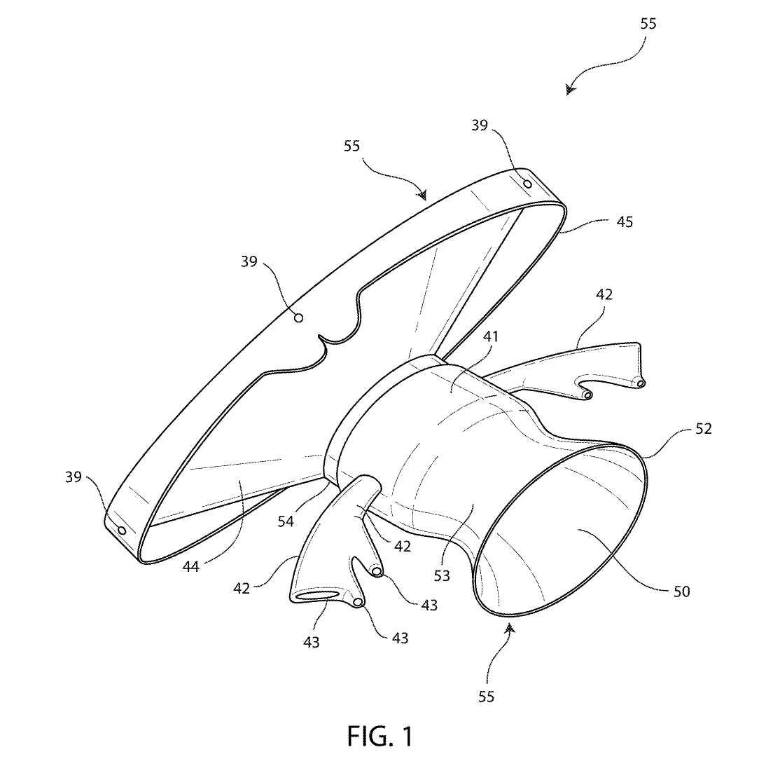

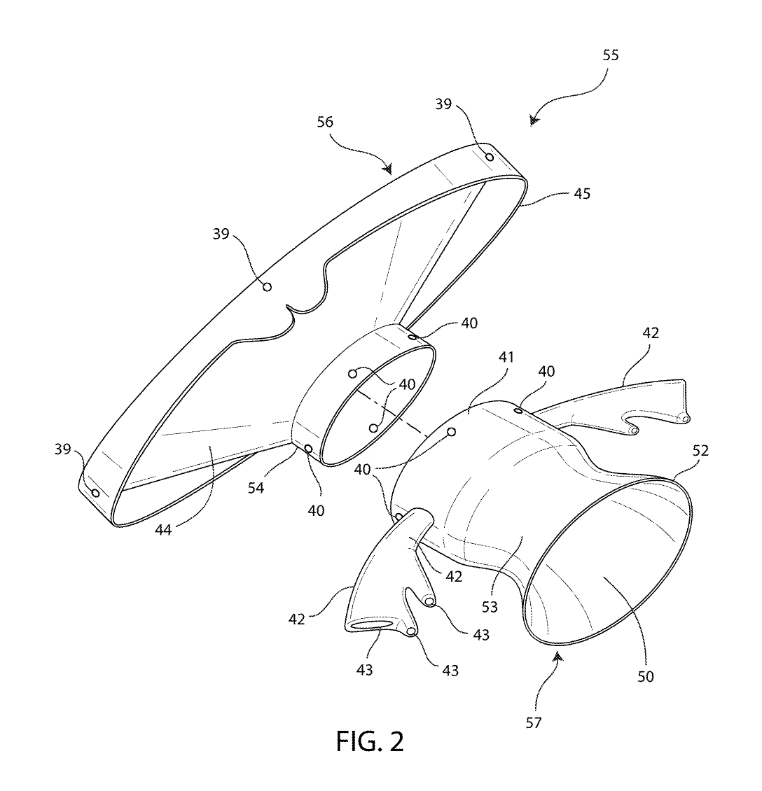

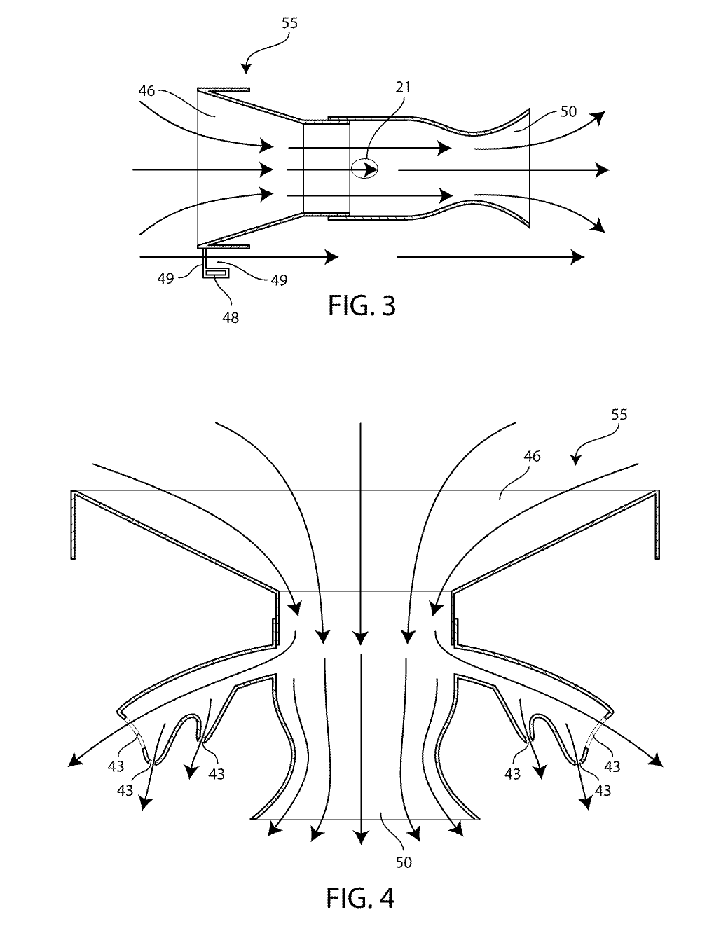

### FIGS. 1-7

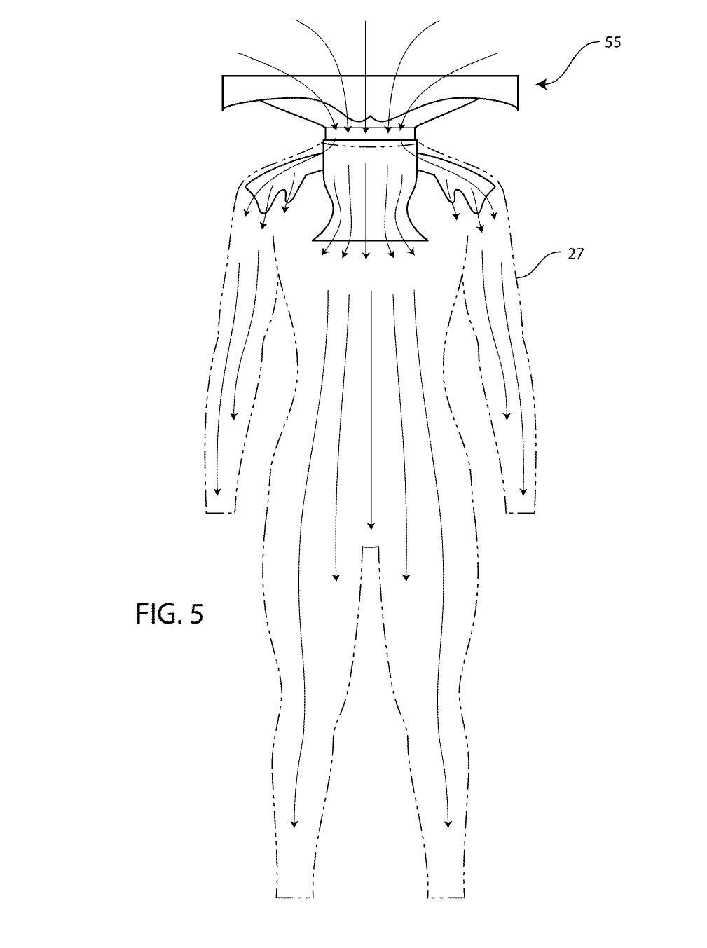

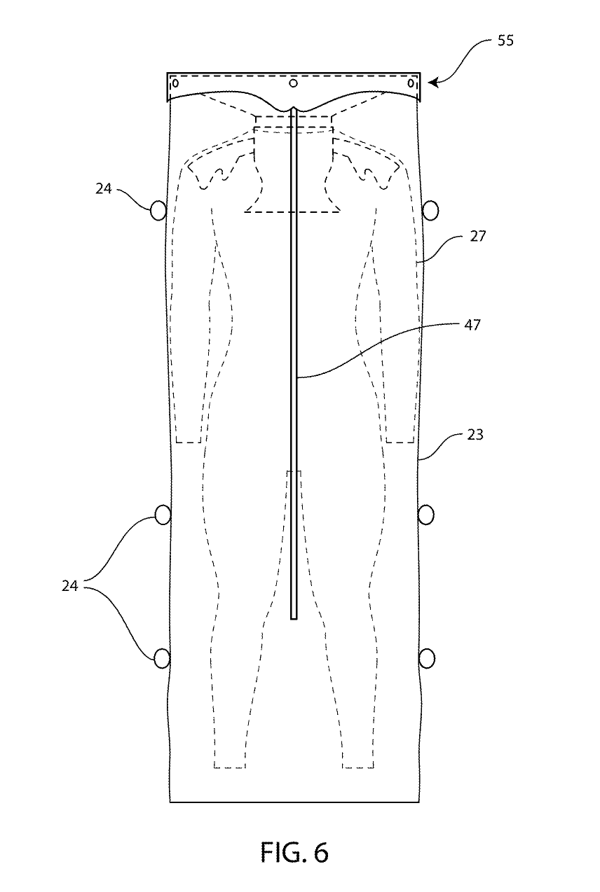

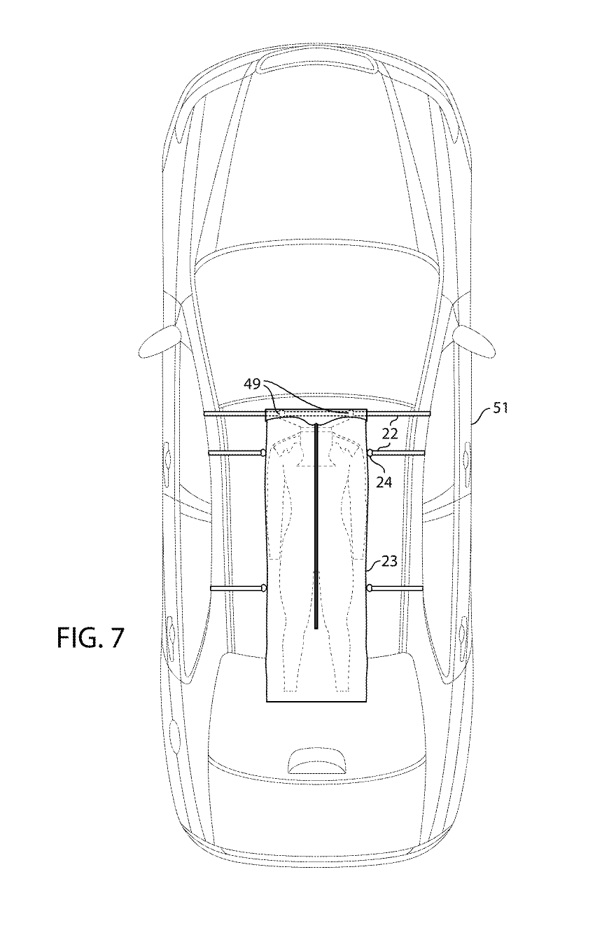

Embodiments of the ventilation device are illustrated in FIGS. 1, 2, and 3 (driver side view), and FIGS. 4, 5, 6, and 7 (top view). The device can comprise a ventilation device and a container. The container can have a base with or without legs consisting of a flexible, durable material which can securely house several garments without compromise to its structure due to the force generated by the wind and the movement of the vehicle. For example, the base can include mesh, micro fiber terry cloth, nylon ripstop, combinations thereof, or the like. For example, the container 23 can be between 0.05 and 610 cm in length, between 0.05 and 305 cm in width, and between 0.05 and 244 cm in height. For example, a preferred range for the container 23 can be between 92 cm and 244 cm in length, between 31 cm and 122 cm in width, and between 5 cm and 122 cm in height. For example, the container 23 can be 177.8 cm in length, 50.8 cm in width, and 10.16 cm in height. The container can have an opening for a strap at its front base 24 (FIGS. 6 and 7) tunneling the width of the container allowing for straps 22 (FIG. 7) to slide through the driver's side and passenger's side of the container to conveniently secure and remove the container to and from the vehicle. The base openings 24 can be between 0.05 and 610 cm in length, between 0.05 and 305 cm in width, and between 0.05 and 244 cm in height. For example, a preferred range for the base openings 24 can be between 1 cm and 31 cm in length, between 0.05 cm and 92 cm in width, and between 1 cm and 31 cm in height. For example, the opening for a strap at its front base 24 can be 3.302 cm in length, 50.8 cm in width, and 0.762 cm in height. The container opening 47 located on top of the container can provide access to the inside of the container. The container opening 47 can include a zipper, buttons, and or any other appropriate method of hook and fasten. The container opening 47 can be of any size, shape, order, and number of openings. For example, the container opening 47 can be between 0.05 and 610 cm in length, between 0.05 and 305 cm in width, and between 0.05 and 244 cm in height. For example, a preferred range for the container opening 47 can be between 76 cm and 198 cm in length, between 0.05 cm and 8 cm in width, and between 0.05 cm and 11 cm in height. For example, the container opening 47 can be 149.86 cm in length, 1.27 cm in width, and 1.27 cm in height. There can be 1, 2, 3 or more container openings. The container storage space can be large enough to fit garments flatly placed and secured inside the container (FIGS. 5, 6, and 7). The container storage space can be large enough and flexible enough to fit garments in any other appropriate manner securely inside the container. The container 23 can attach to beneath the aerodynamic rim 45 of the ventilation device 55 by screw and bolt or any other appropriate method through the front ventilation hole openings 39 of through any size, shape, order, and number prefabricated into the ventilation device. The aerodynamic rim 45 can be between 2 and 15 cm in length, 25 and 75 cm in width, 0.63 cm and 30 cm in height, and 0.01 and 1 cm in thickness. The aerodynamic rim 45 can be between 0.05 and 610 cm in length, between 0.05 and 305 cm in width, and between 0.05 and 244 cm in height. For example, a preferred range for the aerodynamic rim 45 can be between 1 cm and 31 cm in length, between 24 cm and 92 cm in width, and between 1 cm and 22 cm in height. The aerodynamic rim 45 can be 7.62 cm in length, 48.26 cm in width, 5.08 cm in height, and 0.127 cm in thickness. For example, the front ventilation hole openings can be about 0.5, 1, 2, 3 cm or more in diameter. The hole openings can be circular or rectangular or the like. There can be 4, 5, 6, 7, 8. 9, 10 or more hole openings. In one embodiment, the container 23 can be a flexible and durable material, such as mesh, or the like. The container 23 can consist of any other material, and or combination of materials, that can be repeatedly compressed and exposed to force generated from compression and/or the wind and/or movement of the vehicle without tear or fracture, such as vinyl, nylon, high-density polyethylene, polyethylene terephthalate, polyvinyl chloride, low-density polyethylene, polypropylene, polycarbonate, polylactide, any other plastic, microfiber, composite, and the like.

In one embodiment the ventilation device 55 can include a front ventilation 56 and back ventilation 57 portion that can attach together by screw and bolt through any size, shape, order, and number of openings 40 at the neck of the front portion 56 of the ventilation device 55 (FIGS. 1, 2, 3, and 4). The front portion 56 of the ventilation device 55 can contain an aerodynamic aperture 46 of any size, shape, order, and number of openings that can allow the airflow generated from the movement of the vehicle to flow into, through, and around the ventilation device 55 and into, through, and around the garment 27 and out the container 23. For example, the aerodynamic aperture 46 can be circular or rectangular. The aerodynamic aperture 46 can be between 0.05 and 610 cm in length, between 0.05 and 305 cm in width, and between 0.05 and 244 cm in height. For example, a preferred range for the aerodynamic aperture 46 can be between 1 cm and 31 cm in length, between 10 cm and 92 cm in width, and between 1 cm and 92 cm in height. The aperture can be between 2 and 31 cm in length, 10 and 25 cm in width, and 2 and 31 cm in height. The aperture can be 5.08 cm in length, 15.24 cm in width, and 7.62 cm in height. The front portion 56 can be between 10 and 25 cm in length, 25 and 75 cm in width, and 10 and 30 cm in height. The front portion 56 can be 15.24 cm in length, 48.26 cm in width, and 20.32 cm in height. The front portion 56 and any other portion of the ventilation device 55 and container 23 can be stabilized and elevated by legs 49. The legs 49 can contain an opening 48 of any size, shape, order, and number of openings that can allow for a strap and buckle system 22 to slide through and utilized to secure the ventilation device 55 and container 23 to the roof of the vehicle 51. The legs 49 can be composed of any combination of plastic, fabric, metal, composite, or the like. The legs 49 can be between 0.05 and 610 cm in length, between 0.05 and 305 cm in width, and between 0.05 and 244 cm in height. For example, a preferred range for the legs 49 can be between 1 cm and 31 cm in length, between 1 cm and 31 cm in width, and between 1 cm and 92 cm in height. The legs 49 can be 5.08 cm in length, 3.81 cm in width, and 5.08 cm in height. Behind the aperture 46 on the front portion 56 of the ventilation device 55 can be a rib structure 44 of any size, shape, order, and number to provide additional strength and stability to the ventilation device 55. The rib structure 44 can be between 0.5 and 5 cm in length, 3 and 10 cm in width, and 0.1 and 1 cm in thickness. The rib structure 44 can be between 0.05 and 610 cm in length, between 0.05 and 305 cm in width, and between 0.05 and 244 cm in thickness. For example, a preferred range for the rib structure 44 can be between 1 cm and 31 cm in length, between 1 cm and 31 cm in width, and between 1 cm and 92 cm in thickness. The rib structure 44 can be 2.54 cm in length, 6.35 cm in width, and 0.127 cm in thickness. The back portion 57 of the ventilation device 55 can contain hanger arms 42 of any size, shape, order, and number that a garment can be secured to through any opening of the garment 27, such as the neck hole. The back portion 57 can be between 0.05 and 610 cm in length, between 0.05 and 305 cm in width, and between 0.05 and 244 cm in height. For example, a preferred range for the back portion 57 can be between 1 cm and 122 cm in length, between 1 cm and 122 cm in width, and between 1 cm and 122 cm in height. The back portion 57 of the ventilation device be 17.78 cm in length, 43.18 cm in width, and 12.7 cm in height. The hanger arms 42 can contain apertures 43 of any size, shape, order, and number of openings to allow airflow to travel through the device and into, through, and around the shoulders and sleeves of the garment 27. The hanger arms 42 can be between 0.05 and 610 cm in length, between 0.05 and 305 cm in width, and between 0.05 and 244 cm in height. For example, a preferred range for the hanger arms 42 can be between 2 cm and 77 cm in length, between 0.05 cm and 92 cm in width, and between 1 cm and 92 cm in height. The hanger arms 42 can be 15.24 cm in length, 5.08 cm in width, and 1.27 cm in height. In one embodiment the ventilation device 55 can comprise a lightweight and durable plastic such as acrylonitrile butadiene styrene (ABS). However, the ventilation device 55 can consist of any other material, and or combination of materials, that can be repeatedly compressed and exposed to force generated from the wind and movement of the vehicle without tear or fracture, such as vinyl, nylon, high-density polyethylene, polyethylene terephthalate, polyvinyl chloride, low-density polyethylene, polypropylene, polycarbonate, polylactide, any other plastic, composite, and the like.

The back portion 57 of the ventilation device 55 can contain an elevated lip 52 opening the inside of the garment 27 to maximize airflow and the exsiccation of the garment 27. The elevated lip 52 can be between 0.05 and 610 cm in length, between 0.05 and 305 cm in width, and between 0.05 and 244 cm in height. For example, a preferred range for the elevated lip 52 can be between 2 cm and 61 cm in length, between 0.05 cm and 92 cm in width, and between 1 cm and 92 cm in height. The elevated lip 52 can be 5.08 cm in length, 20.32 cm in width, and 12.7 cm in height. The slight concave 53 in the rear neck 41 of the back ventilation device 57 can create a partial reverse of airflow back into the device, through the hangers 42 and out the apertures 43 located in any size, shape, order, and number throughout the hangers 42 traveling into, through, around and further exsiccating, but not limited to, the shoulders and sleeves of the garment 27. The slight concave 53 can be between 0.05 and 610 cm in length, between 0.05 and 305 cm in width, and between 0.05 and 244 cm in height. For example, a preferred range for the slight concave 53 can be between 0.05 cm and 92 cm in length, between 0.05 cm and 92 cm in width, and between 1 cm and 107 cm in height. The slight concave 53 can be 5.08 cm in length, 15.24 cm in width, and 8.89 cm in height. The rear neck can be 7.62 cm in length, 17.78 cm in width, and 8.89 cm in height.

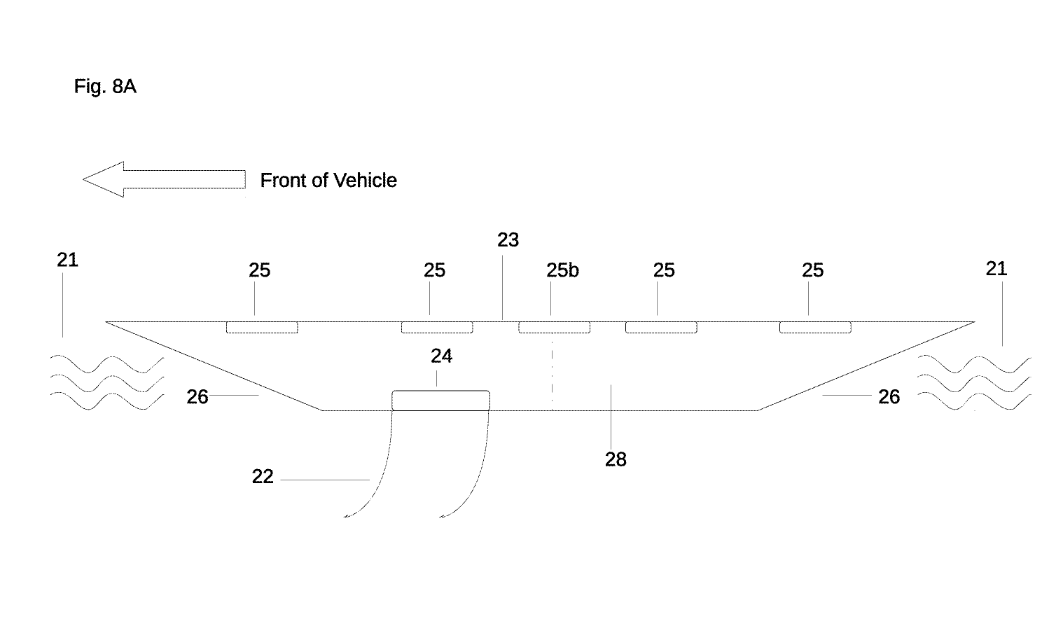

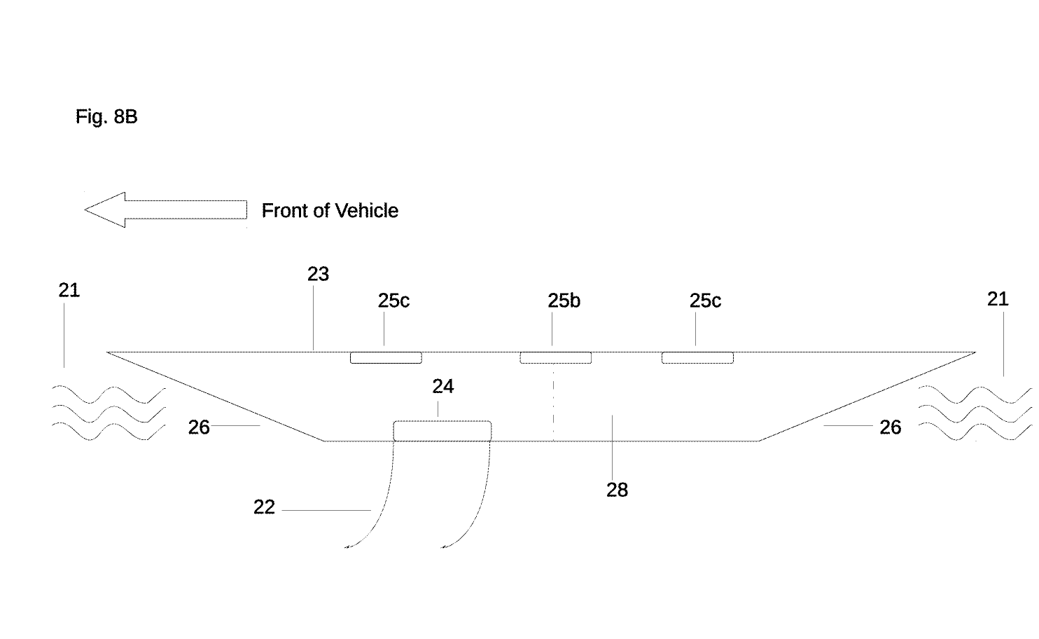

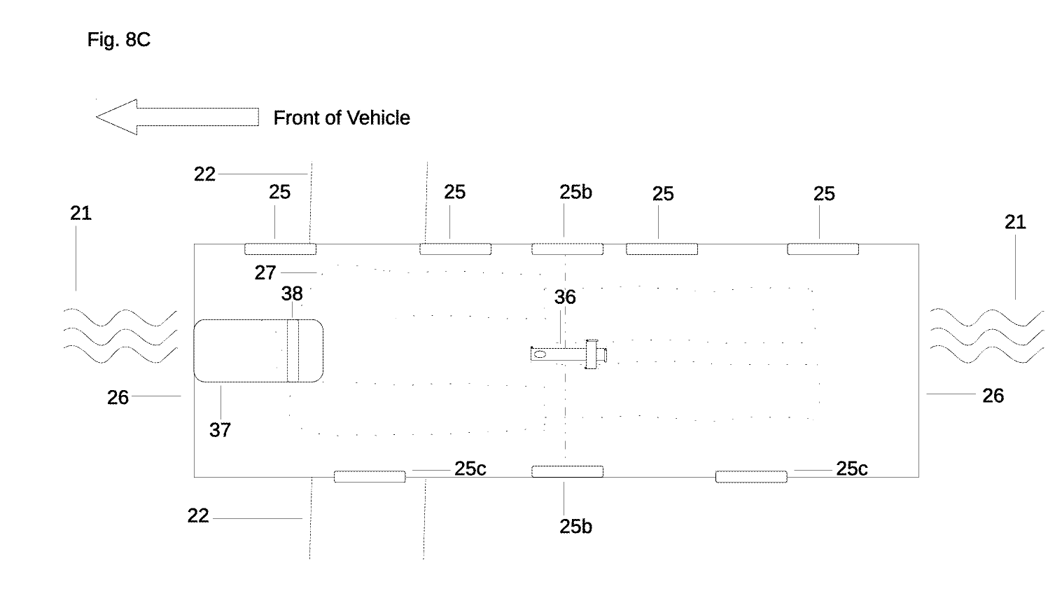

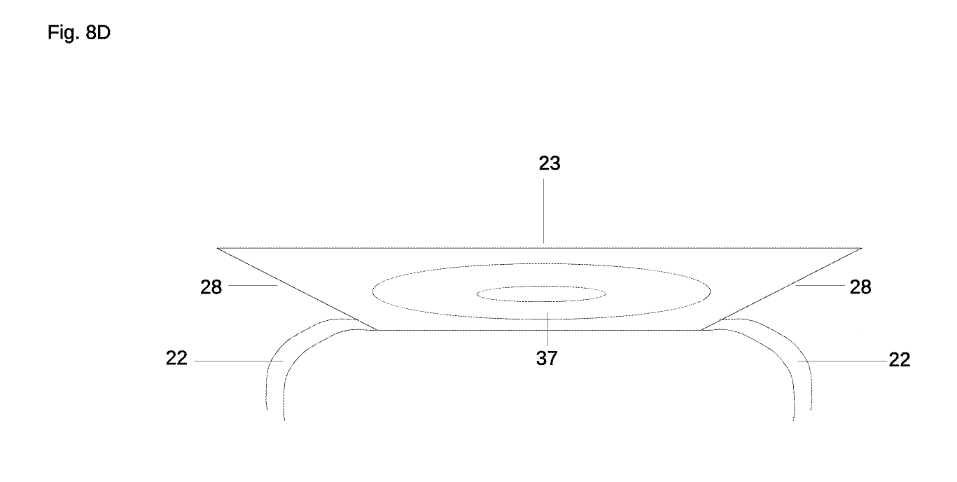

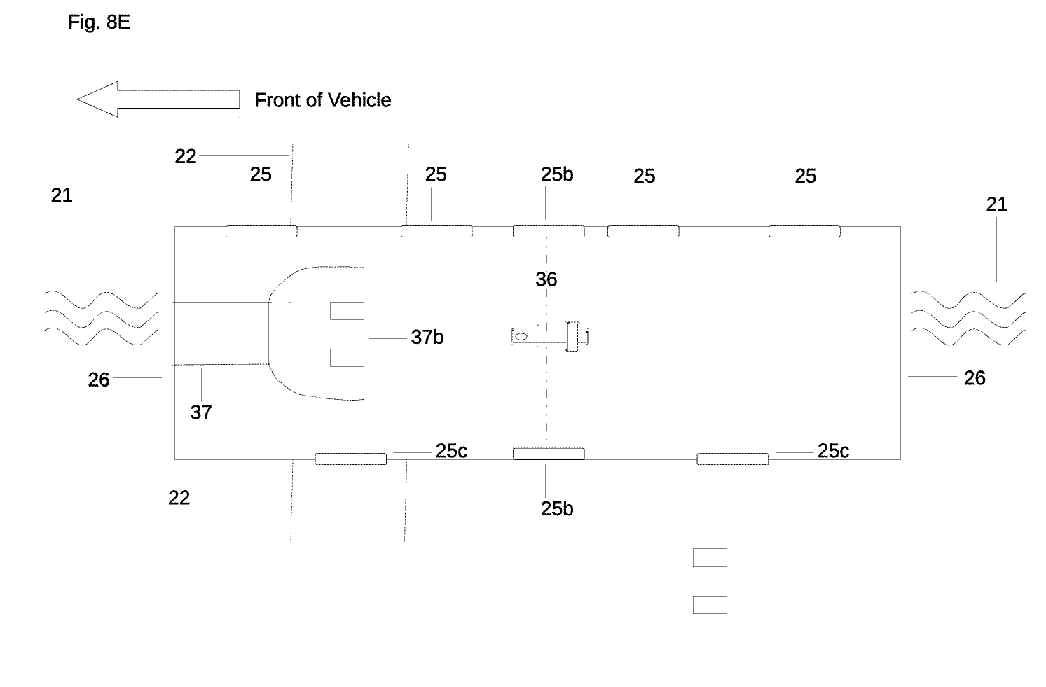

The front and back of the container can include aerated openings 26 (FIGS. 8A, 8B, 8C, 8D, and 8E) interwoven into the structure of the walls of any size, shape, order, and number to allow for the maximum amount of wind 21 (FIGS. 8A, 8B, 8C, and 8D) to aerodynamically and most efficiently flow through the container and through the material to exsiccate the material secured inside the container. The front, and any other needed areas of the container, can contain an aperture apparatus 37 (FIGS. 8C, 8D, and 8E) that can allow for the maximum amount of wind to flow through the container and into, through, and around the garment 27. The aperture apparatus 37 can be of any appropriate size, shape, and number (FIGS. 8C, 8D, and 8E). The aperture apparatus 37 can be between 0.05 and 610 cm in length, between 0.05 and 305 cm in width, and between 0.05 and 244 cm in height. For example, a preferred range for the aperture apparatus 37 can be between 1 cm and 122 cm in length, between 1 cm and 122 cm in width, and between 1 cm and 122 cm in height. The aperture apparatus 37 can be 5.08 cm in length, 15.24 cm in width, and 7.62 cm in height. The garment 27, such as a wetsuit or jacket or snow suit, can be secured to the ventilation device 55 by zipping the garment 27 closed while placed over the hangers 43 of the back portion 57 of the ventilation device 55 and further secured with a strap 38 (FIG. 8C), hooks, buckle, Velcro, clamps, and or any other appropriate means if desired. The ventilation device 55 can exsiccate multiple garments with an attachment 37b (FIG. 8E) that allows for the air flow to be distributed through multiple ventilation channels and is shaped and placed in any appropriate size or manner. The multiple garments attachment 37b can attach to the front portion 56 of the ventilation device 55 through snug fit, hooks, clamps, buckles and or any other appropriate means and is made of a flexible, sturdy plastic, such as acrylonitrile butadiene styrene (ABS). However the attachment 37b can consist of any other material, and or combination of materials, that can be repeatedly compressed, secured, and exposed to force generated from the wind and movement of the vehicle without fracturing, such as vinyl, nylon, high-density polyethylene, polyethylene terephthalate, polyvinyl chloride, low-density polyethylene, polypropylene, polycarbonate, polylactide, any other plastic, composite, and the like.

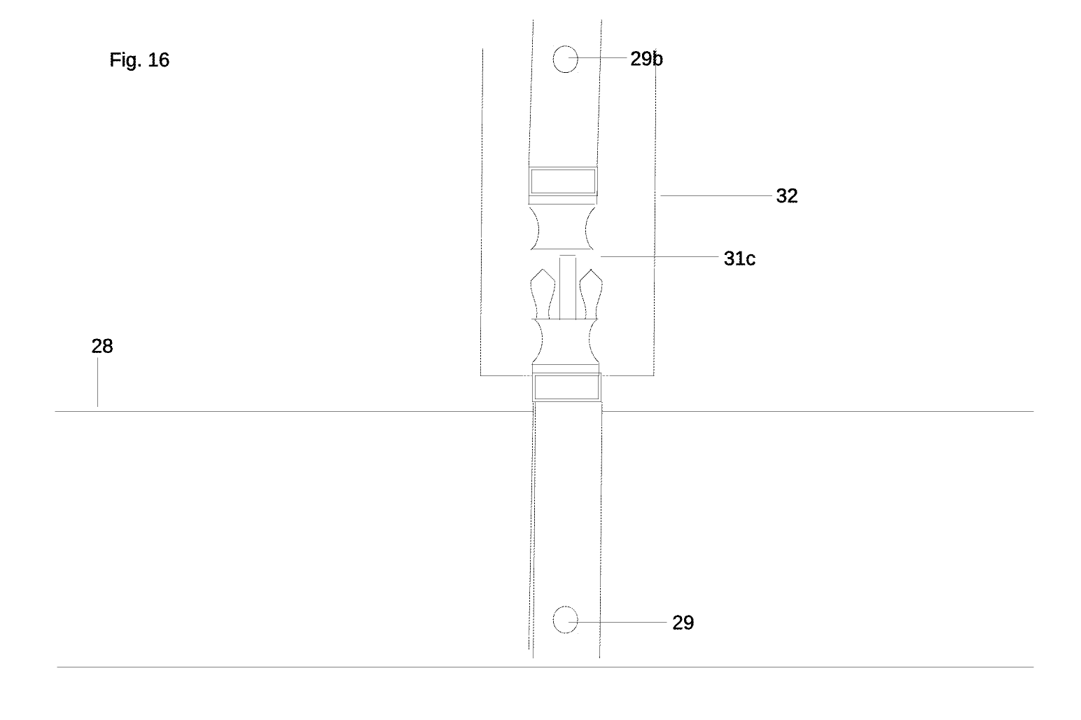

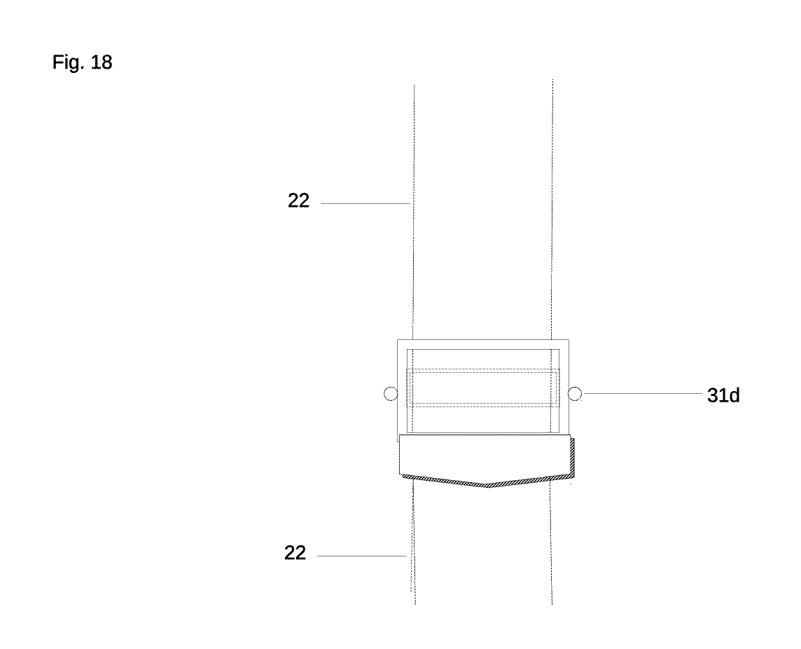

The strap and buckle system 22 (FIGS. 8A, 8B, 8C, 8D, 8E, 16, 17, and 18) can slide through the openings 24 at the base of the driver's side and passenger's side of the container tightening the container to the roof of the vehicle by entering inside the top of the vehicle while the doors are open and securing to the ceiling of the inside of the vehicle by a strap and buckle system 22. Once the strap and buckle system 22 is tightened into place, the excess length of the strap can be secured to the bottom of the strap hugging the inside ceiling of the vehicle with hooks and fastener, a clamp, button, pin, or by any other appropriate means.

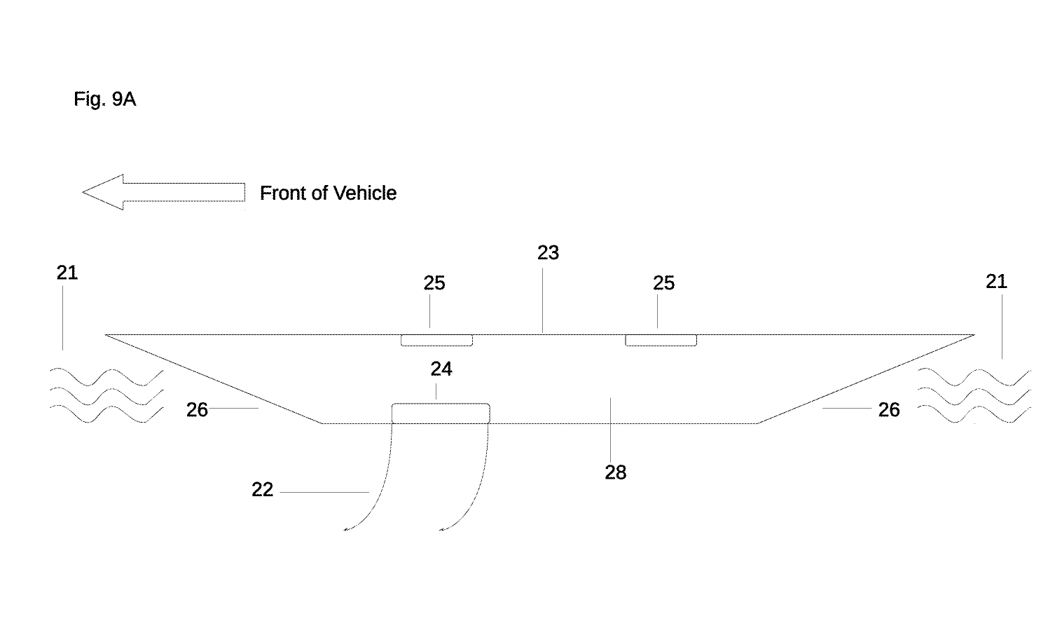

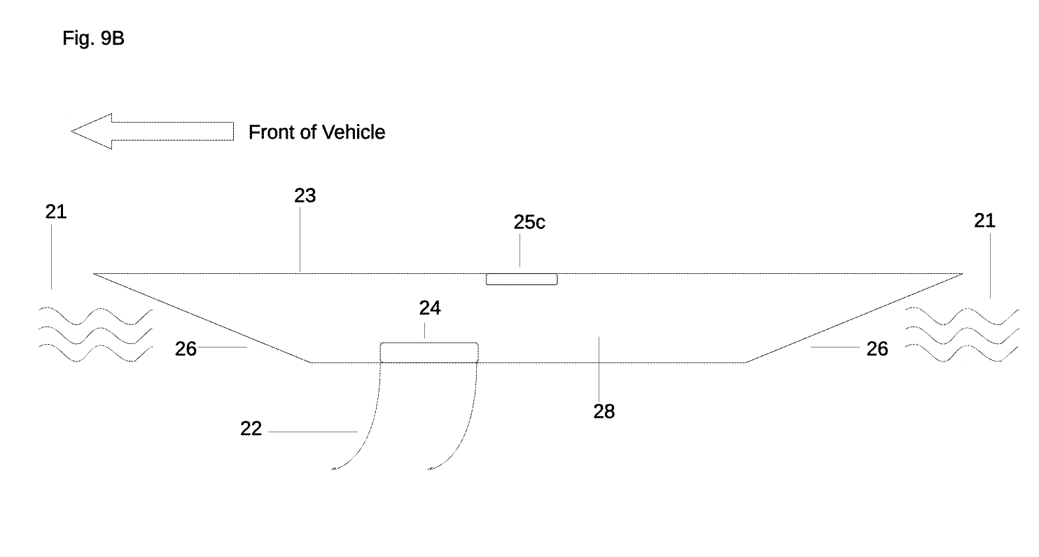

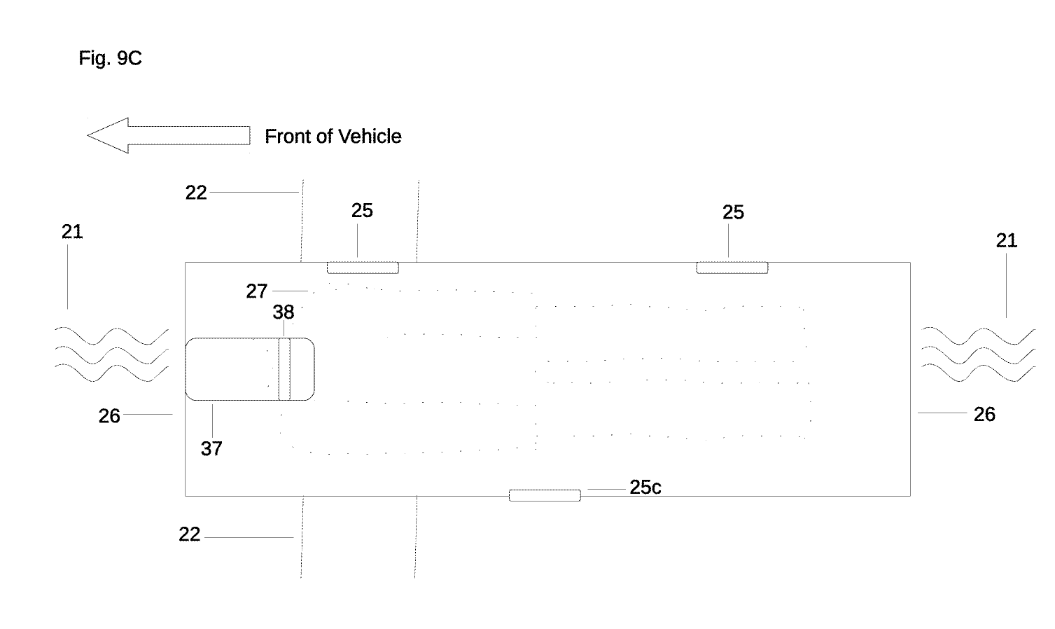

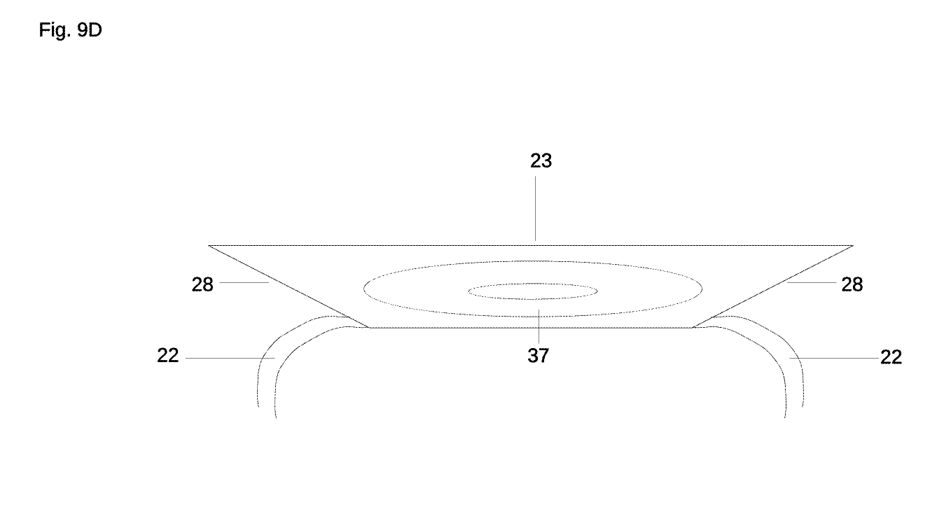

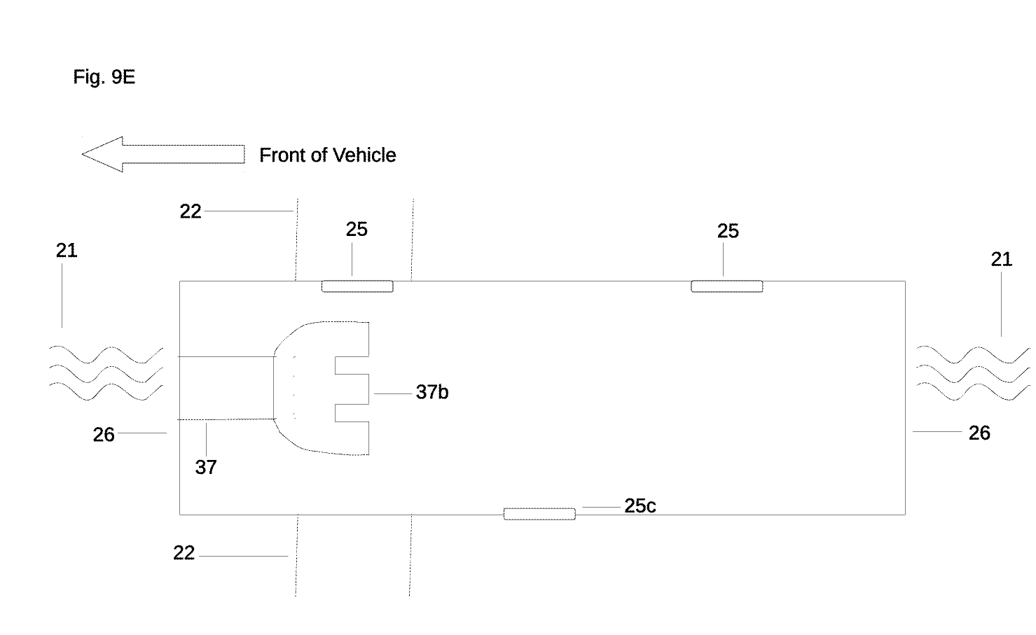

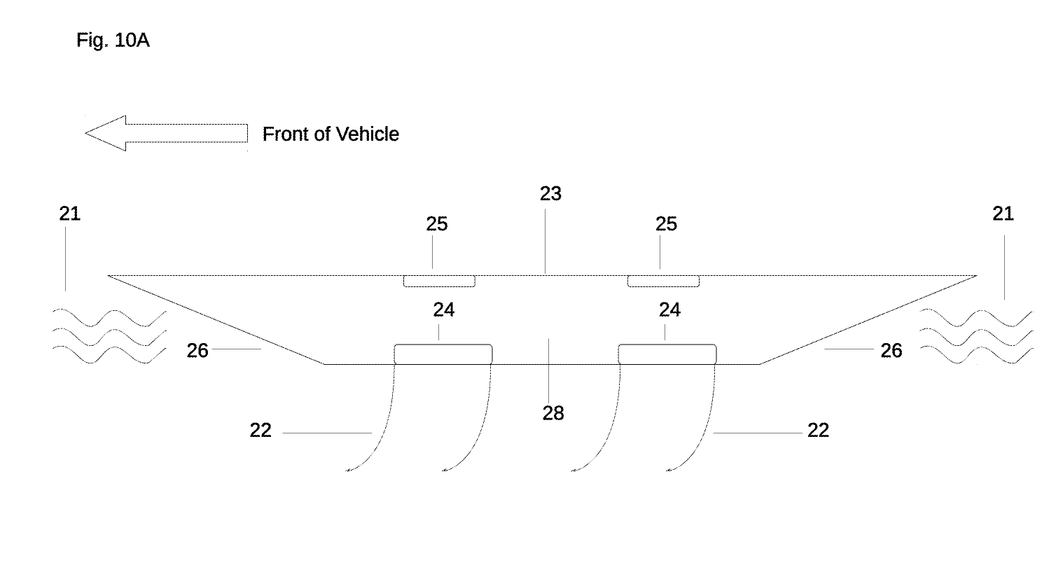

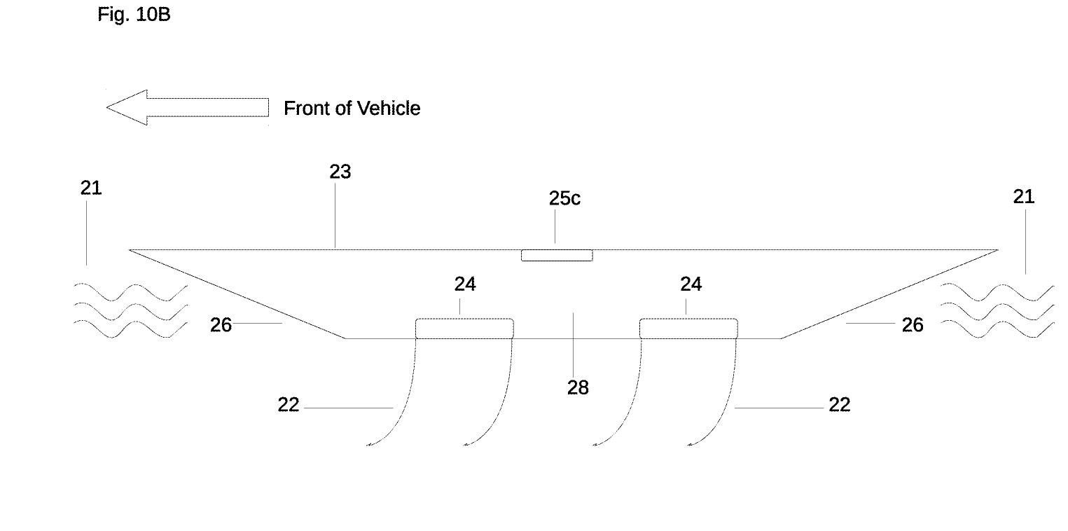

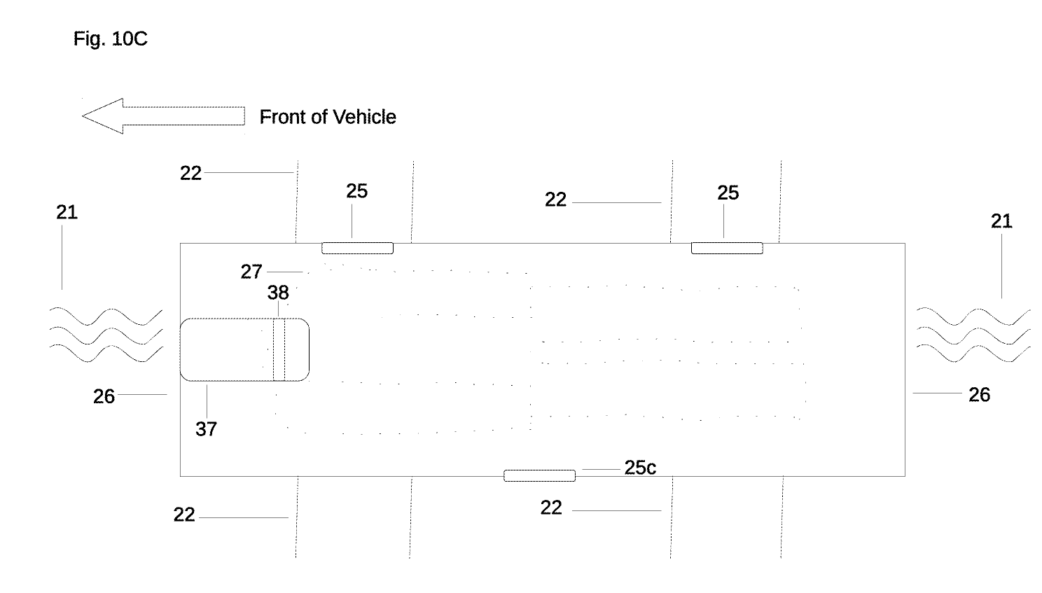

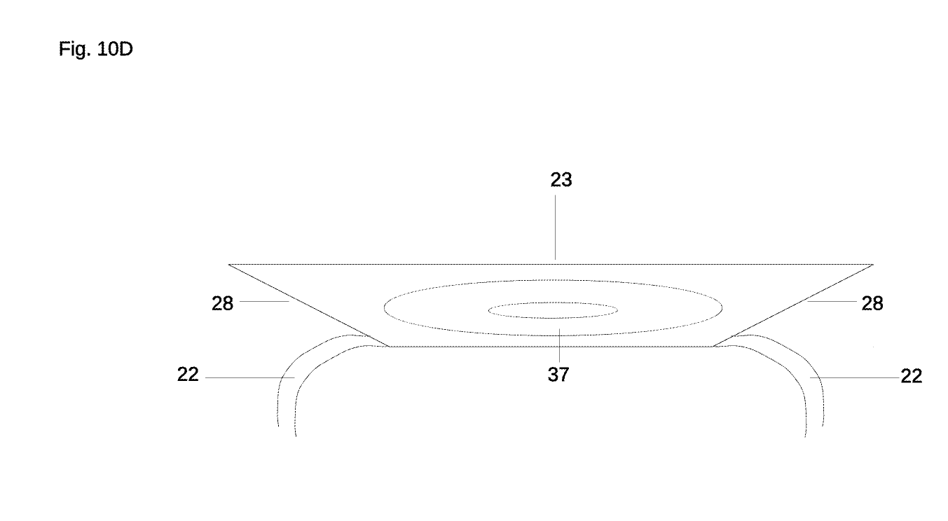

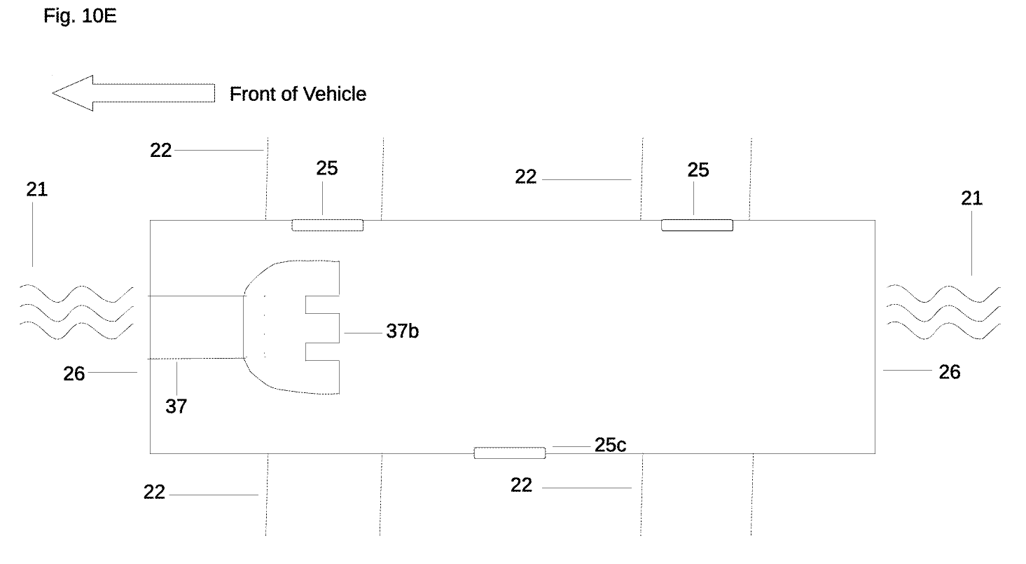

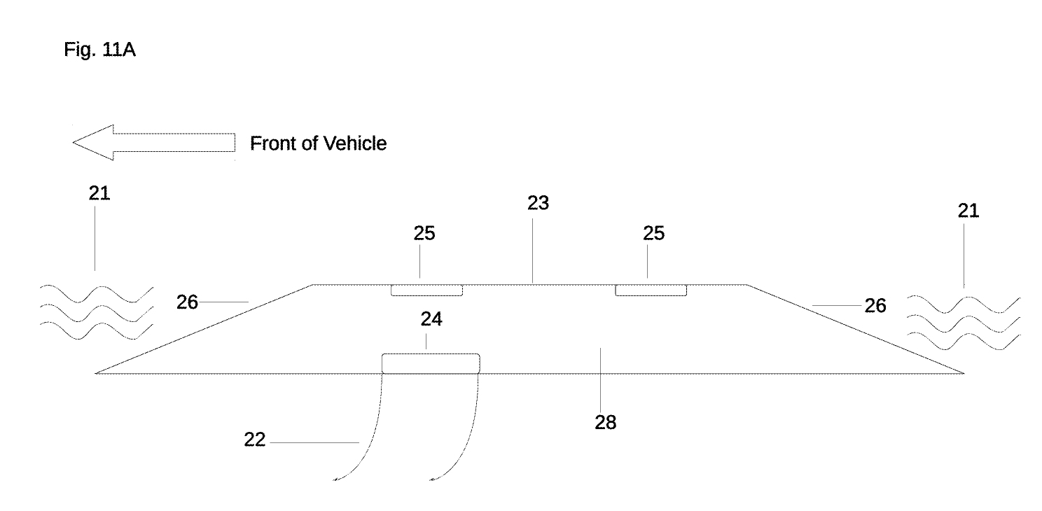

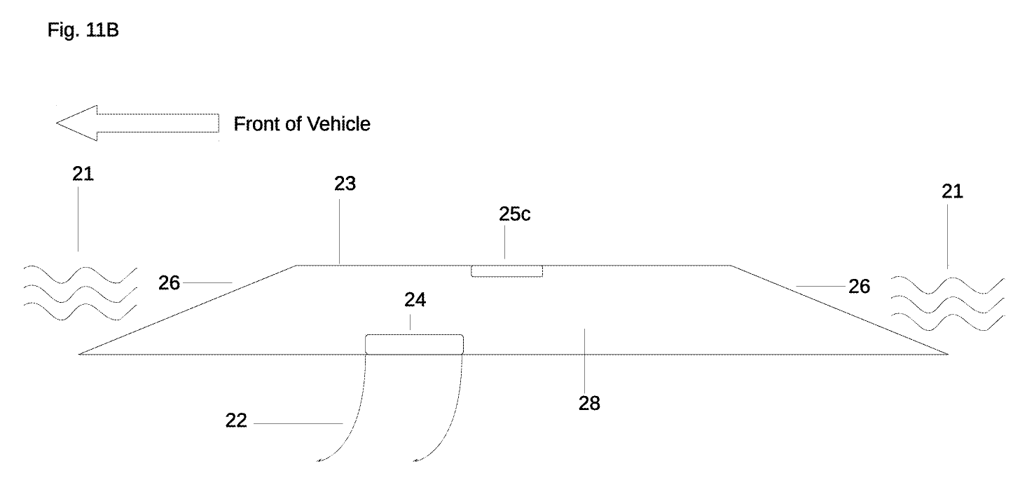

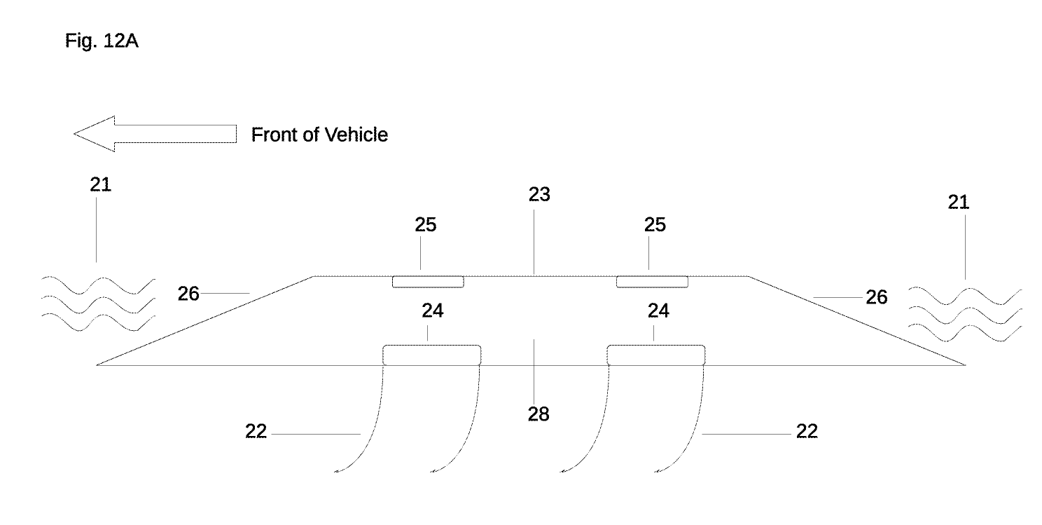

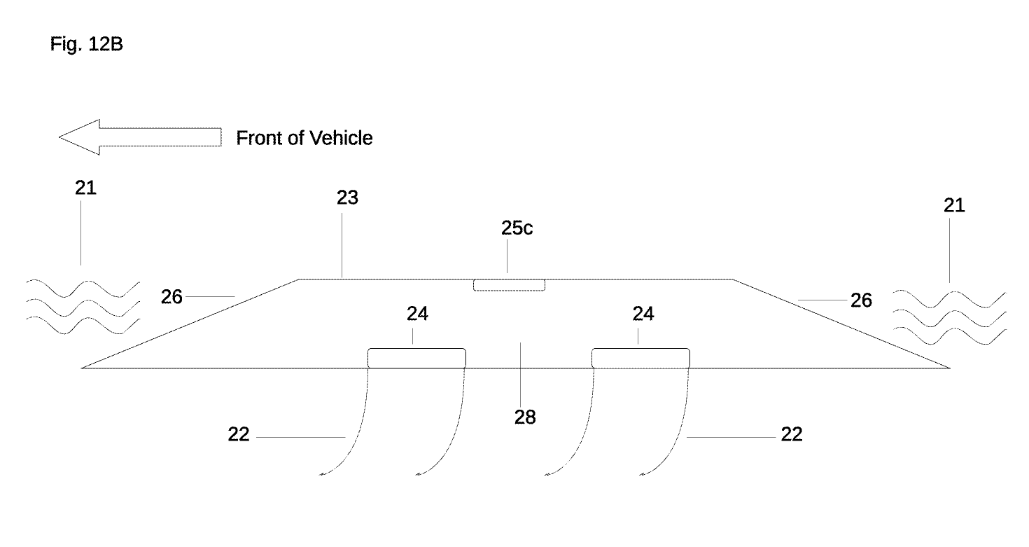

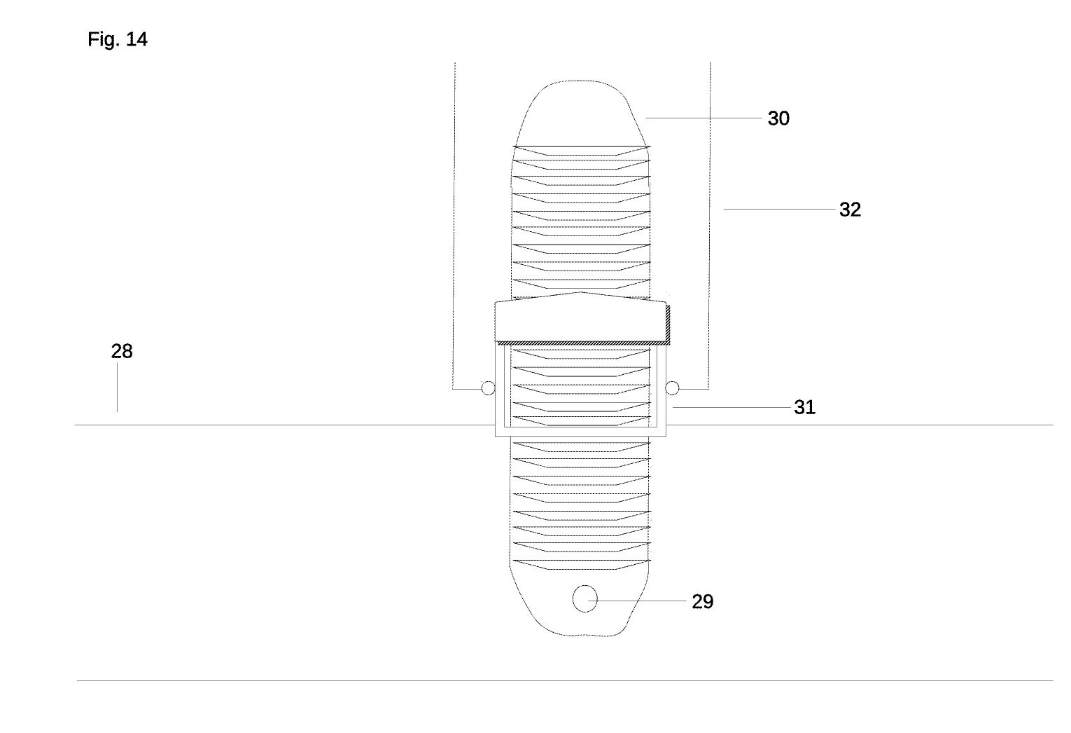

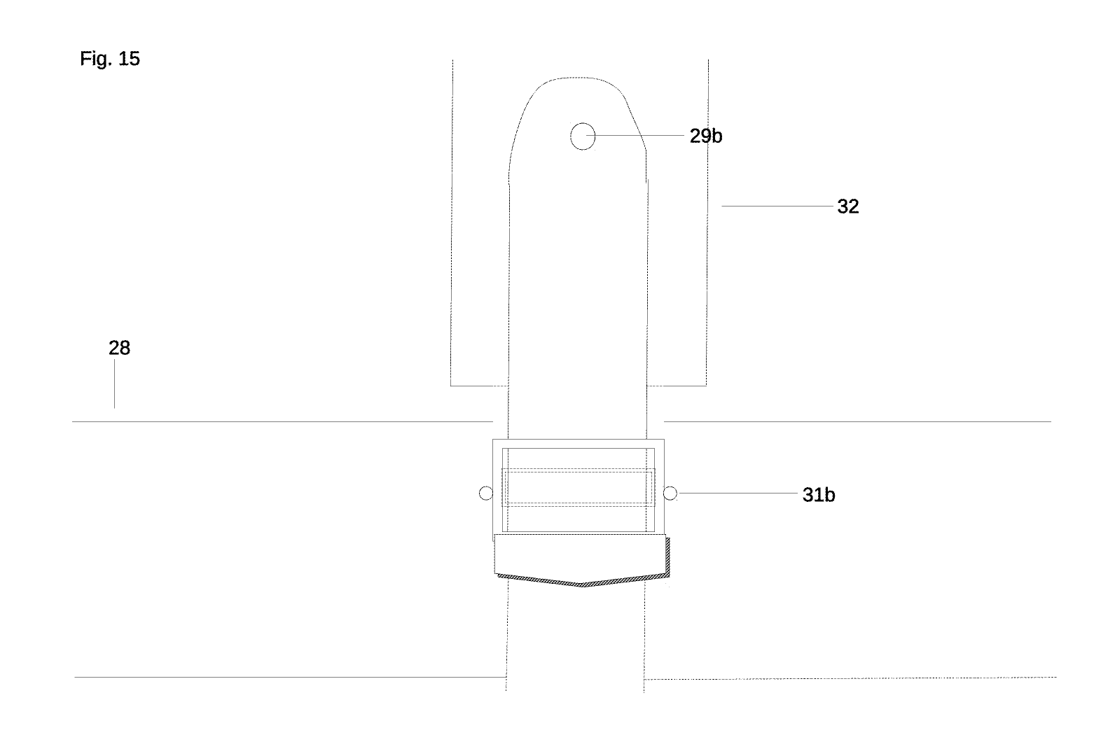

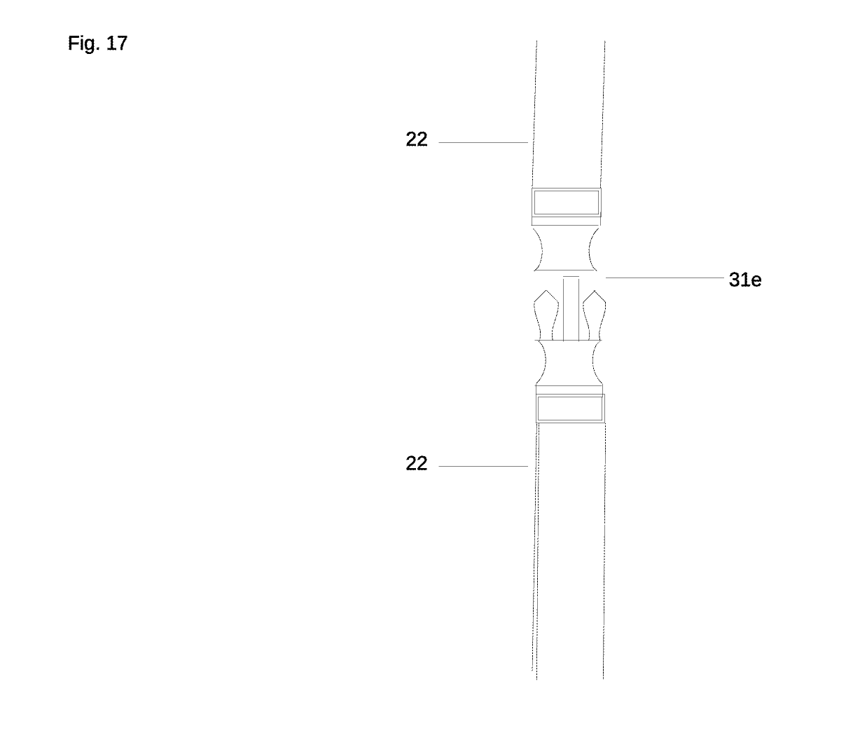

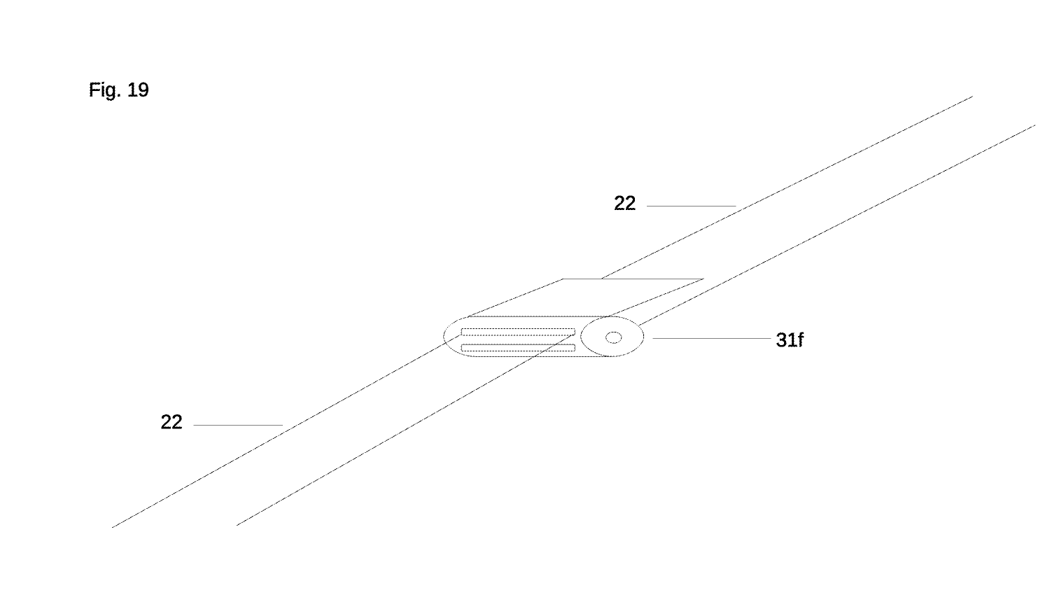

In some embodiments the container can be formed in various aerodynamic shapes (For example in FIGS. 11A, 11B, 12A, and 12C). FIGS. 9A, 10A, 11A and 12A are shown from the passenger's side view of the vehicle while FIGS. 9B, 10B, 11B and 12B are from the driver's side of the vehicle. Any shape or combination of shapes can be considered part of the aerodynamic design of the container. For example, the container can be rectangular, circular, or the shape of the water garment, or the like. The container can also have various placements and number of hinges 25 (FIGS. 9A, 9B, 9C, 9E, 10A, 10B, 10C, 10E, 11A, 11B, 12A, 12B) built anywhere into its design. The hinges 25 can be between 0.05 and 610 cm in length, between 0.05 and 305 cm in width, and between 0.05 and 244 cm in height. For example, a preferred range for the hinges 25 can be between 1 cm and 183 cm in length, between 0.05 cm and 46 cm in width, and between 1 cm and 92 cm in height. The hinges 25 can be 3.81 cm in length, 3.81 cm in width, 7.62 in height, and 0.127 cm in thickness. The container can have 2, 4, 5, 6, 7, 8, or more hinges. In some embodiments, the container has no hinges. In absence of the additional hinges 25 the container can have variant amounts of ratchet systems 25c (FIGS. 9A, 9B, 9C, 9E, 10A, 10B, 10C, 10E, 11A, 11B, 12A, 12B). The container can also be produced without the hinges 25b (FIGS. 9A, 9B, 9C, 9E, 10A, 10B, 10C, 10E, 11A, 11B, 12A, 12B) depending upon final material selection. The container can also be produced with various amounts and placements of openings 24 (FIGS. 10A, 10B, 10C, 10E, 12A, 12B). The container can also utilize various placements, amounts, and types of strap, buckle and ratchet systems 31 (FIGS. 14, 15, 16) as appropriate for securing and compressing the garments inside the container. The container 23 can also utilize various placements, amounts, and types of strap, buckle and ratchet systems 31d, 31e, 31f (FIGS. 17, 18, 19) as appropriate for securing the container to the roof of the vehicle. The container 23 and or ventilation system 55 can also secure to the roof of a vehicle by any fastener or securing mean or other means and number such as industrial suction cup and or hook, hook and loop, and or magnet. The suction cups and or hooks and or magnets can be composed of polymer and synthetic rubber, fluoropolymer elastomer, vinyl, urethane, high-density polyethylene, polyethylene terephthalate, polyvinyl chloride, low-density polyethylene, polypropylene, polycarbonate, polylactide, iron, cobalt, nickel, brass, steel, aluminum, and any other plastic, rubber, metal, composite, and the like, and/or combinations thereof. The suction cups and or hooks and or magnets 25 can be between 0.05 and 610 cm in length, between 0.05 and 305 cm in width, and between 0.05 and 244 cm in height. For example, the preferred range for the suction cups and hooks can be between 1 cm and 183 cm in length, between 0.05 cm and 46 cm in width, and between 1 cm and 92 cm in height. The suction cups and or hooks and or magnets can be 3.81 cm in length, 3.81 cm in width, 7.62 in height, and 0.127 cm in thickness.

### METHODS

The manner to place garments into the container can be performed by ensuring the container is first unfolded and placed on a semi flat space. Next the opening 47 of the container can be unzipped. With the entire opening 47 engaged the user can now have full access to the storage capacity of the container. The garments can be placed flat and or in any other appropriate manner into the container. An aperture of the water sport garments, such as the neck opening of the garment 27, can be secured to the hangers 42 of the back portion 57 of the ventilation device 55 the opening 47 is returned to the closed position. If the garment 27 neck is secured to the hangers 42, the garment 27 can then be zipped closed to provide extra securement to the front back portion 57 of the ventilation device 55. If multiple garments are desired to be exsiccated simultaneously, the front aperture apparatus attachment 37b can be secured to the front aperture apparatus 37 by interlocking clips, and then the aperture of each garment can be secured to the aperture of the front aperture apparatus attachment 37b and then the opening 47 is closed. Once the opening 47 is closed, the container 23 can be compressed in any manner and/or allow for air to flow through to removing excess water from the garment 27.

In some embodiments, the roof rack garment exsiccation container is secured to the vehicle 51 via opening the driver's side and passenger's side doors, placing the container on the roof of the vehicle 51, sliding it over, underneath and or between any preexisting roof racks if needed. Once placed flat on the roof of the vehicle 51 with the straps 22 hanging over each side towards the front end of the roof, the user can then sit inside the vehicle 51 to gain easy access to both straps 22. The driver's side and passenger's side straps 22 can then be connected by the strap and buckle system 31e at the ceiling of the vehicle from inside the vehicle. Once the strap and buckle system 31e is locked in place, the straps 22 can be tightened securing the container and its contents to the roof of the vehicle. The excess length of the straps 22 can then secured to the bottom of the strap hugging the inside ceiling of the vehicle with hook and fastener, a clamp, button, pin, or by any other appropriate means. The roof rack garment exsiccation container is now secured and safe for its intended use.

The airflow 21 can be generated from the movement of the vehicle 51 flows into, through, and around the ventilations system 55 and then into, through, and around the garment 27 exiting the container 23 through an aerated opening 26. The airflow 21 can travel through an aerated aperture 46 and neck 54 of the front portion 56 of the ventilation device 55. The airflow 21 then can travel into the rear neck 41 and its slight concave 53 of the back portion 57 of the ventilation device 55. The slight concave 53 of the rear neck 41 can force the airflow 21 to return into the back portion 57 of the ventilation device 55 and into, through and around the hanger arms 42 exiting the hanger arms 42 through apertures 43 and into the shoulders, arms, and sleeves of the garment 27. The elevated lip 52 of the back portion 57 of the ventilation device 55 can expand the inside of the garment 27 secured to the hanger arms 42 and the back portion 57 of the ventilation device to maximize airflow 21 into, through and around the garment 27 increasing exsiccation of the garment 27.

When the vehicle 51 has come to a complete stop and is disabled, the user can safely remove the roof rack garment exsiccation container from the roof. In some embodiments this can be performed by the user opening the driver's side and passenger's side doors, loosening any excess length of the straps 22 that was secured, for example, with hook and fastener, a clamp, button, pin, or by any other appropriate means. The user can then release the tension in the straps 22 by unfastening the strap and buckle system 31e. The user can then remove the container from the roof of the vehicle 51 through the same path it was placed on the vehicle 51. Once removed from the roof of the vehicle 51, the container can be placed on a relatively flat surface.

The manner to remove the garment out of the container can be performed by first entering the opening 47 of the container 23 by the reverse of the same means in which it was closed. Once the container 23 is fully opened the user can lift and remove the stored garments from the hangers 42 of the ventilation device 55 and out of the container 23. For storage, the user can return the lid 23 to its closed position.

In some embodiments, to store the garment exsiccation container in the vehicle while not in use, the user can fold or roll the container 23 to the desired shape or size allowable and appropriate to the dimensions and material of the container 23.

In some embodiments, the roof rack garment exsiccation container can be hung in a location of the user's choice when not attached to, or stored in the vehicle; the user can secure the opposite ends of the straps 22 together by connecting the buckle or ratchet system 31 and creating half of a loop. The straps 22 can then be adjusted to create the desired size of the loop.

The container can then be hung perpendicularly to the ground from various objects with the garments still remaining stored inside. This can allow for further exsiccation and drainage of the stored garments if so desired or needed as any excess liquid escapes through the aerated opening 26 closest to and parallel with the ground.

From the description above, a number of advantages of some embodiments of my roof rack garment exsiccation container become evident:
(a) A container that can utilize the force of the wind generated by the movement of a vehicle to quickly exsiccate wet garments, for example, while driving home from sporting activities involving water or snow.
(b) A container that can be compatible with most preexisting roof racks which still allows for said roof racks to carry cargo while the container is in use, for instance, while carrying surfboards.
(c) A container that can carry and exsiccate multiple garments simultaneously. This can be utilized to exsiccate water and snow and other outdoor gear, such as wetsuits, swimsuits, towels, jackets, snow bibs, snow suits, boots and gloves used for ski or snowboarding, and the like.
(d) A container that can be quickly and easily secured to and removed from the roof of a vehicle without the need for any use of tools, attachments, or modifications to the vehicle.
(e) A container that can be compact and quickly folds or rolls in any manner in half for secure and convenient storage of the container when not in use, for example, inside the vehicle while the user is partaking in a sport.
(f) With the use of the container this can extend the usability of the garments and reduce the risk of bacterial buildup in the garment and or its surrounding storage area.
(g) A container that can be removed from the vehicle once parked and then hung in a secure and proper location at the user's discretion, for example, it may be hung in the shower or on a clothesline outside.
(h) A container that can be used as a standing mat while changing in and out of one's garment to prevent the transfer of unwanted material into one's clothes or vehicle.

### EXAMPLES

The following non-limiting examples are provided to further illustrate embodiments of the invention described herein. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the instant disclosure, appreciate that many changes can be made in the specific embodiments that are disclosed and still obtain a like or similar result without departing from the spirit and scope of the application.

### Example 1

### Drying Time

At 10 minutes at an average of 35 miles per hour, the ventilation device 55 and container 23 exsiccated a 3.2 mm watersport garment 27. At 20 minutes at an average of 45 miles per hour, the ventilation device 55 and container 23 exsiccated a 5 mm watersport garment 27. As would be understood in the art, exsiccation of the watersport garment will vary depending upon, but not limited to, climate, speed, and traffic and road conditions, and other environmental factors.

### Example 2

### Alternatives to Container Design

Additional embodiments of the invention are shown in FIGS. 8, 9, 10, 11, and 12; in each case the aerodynamics, lid 23 hinge 25 placement, center hinge 25b folding, ratchet systems 25c, openings 24, strap, buckle and ratchet systems 31, 31b, 31c, 31d, 31e, and 31f of the garment exsiccation container provide examples, but not limitations to the variety of options for design. In FIGS. 8, 9, and 11 the container can have only one opening 24 tunneling through the driver's side and passenger's side of the container. In FIGS. 10 and 12 it can have two openings 24. FIGS. 11 and 12 provide options though not limitations to the aerodynamic design of the container. FIGS. 17, 18, and 19 illustrate examples of, but not limitations to, ratchet, strap, and buckle systems 22 and 31, 31b, 31c, 31d, 31e, and 31f to secure the container to the vehicle. FIGS. 14, 15, and 16 demonstrate, but do not limit, ratchet, strap, and buckle systems to secure and compress the garments stored inside the container while in use.

### Example 3

### Alternatives to Container Design

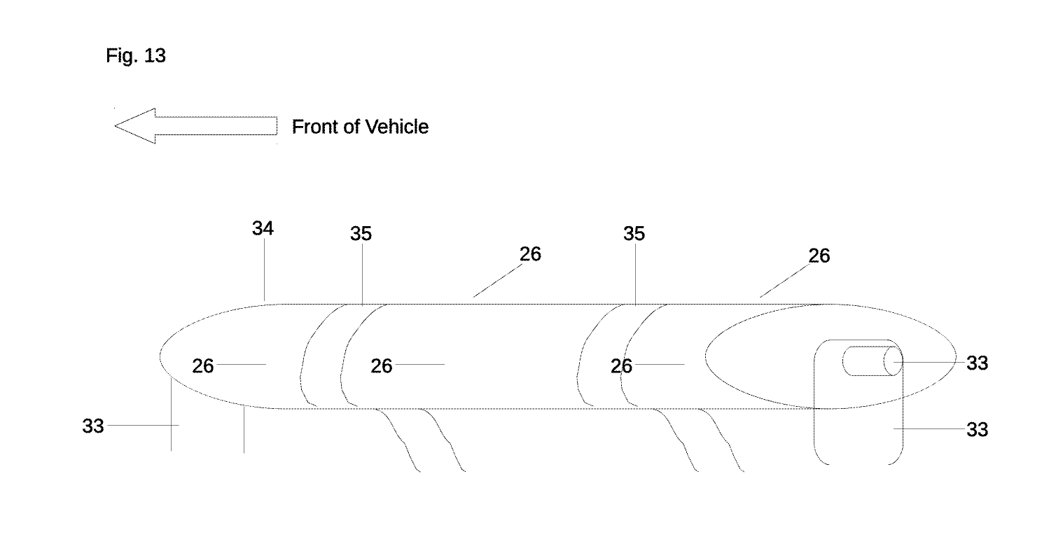

There are various possibilities with regard to the relative design of the container depending upon the selection of material type. The ventilation system 55 may be designed to fold and or unfold in any manner that would further enhance the compactness and or efficiency of the device. FIG. 13 shows an aerated container that can wrap around the brace of a roof rack and is secured in place with a strap and buckle system. This can be a durable, lightweight, nylon mesh bag with straps; a vehicle compatible wet shop-vac and vacuum bag that allows for the immediate exsiccation of wet materials stored inside; a horizontal and or vertical power generating windmill inserted into and or on the device, for instance inside the opening aperture 46, connected to any electrical and or vibratory method of harnessing power and transmitting it to be utilized to alter the temperature of the container and or its garments and or generate power for other various uses; and, but not limited to, a design similar to FIG. 1 composed of an appropriate flexible material allowing for the container to take multiple shapes dependent upon user preference.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the invention disclosed herein are illustrative of the principles of the embodiments of the invention. Other modifications that can be employed can be within the scope of the invention. Thus, by way of example, but not of limitation, alternative configurations of the embodiments of the invention can be utilized in accordance with the teachings herein. Accordingly, embodiments of the present invention are not limited to that precisely as shown and described.

What is claimed is:

1. A system for exsiccation of a material object comprising a ventilation device,
wherein the ventilation device comprises a front portion and a back portion,
wherein the front portion comprises the front of an aerodynamic aperture,
wherein the back portion comprises the back of the aerodynamic aperture and means to attach the material object
wherein air can travel through into the front portion, out the back portion and on to the material object when the material object is attached to the back portion and when the system is attached to a body in motion.

2. The system of claim 1 wherein the back portion comprises one or more additional openings for air to travel through to the material object when the material object is attached to the back portion and when the system is attached to a body in motion.

3. The system of claim 1 further comprising a container for the ventilation device and the material object, wherein the container is connected to the ventilation device.

4. The system of claim 1 wherein the back portion comprises one or more additional openings for air to travel through and into the container when the container is attached to the ventilation device and when the system is attached to a body in motion.

5. The system of claim 1 where in the back portion comprises hanger arms on the sides of the back portion.

6. The system of claim 1 wherein the hanger arms are hollow and comprise one or more additional openings for air to travel through the hanger arms and on to the material object.

7. The system of claim 1 wherein the back portion is a hourglass shape.

8. The system of claim 1 wherein the back portion has a neck and that is smaller in circumference than the aperture.

9. The system of claim 1 wherein the ventilation device comprises a material selected from the group consisting of high-density polyethylene, polyethylene terephthalate, polyvinyl chloride, low-density polyethylene, polypropylene, polycarbonate, polylactide, any other plastic, nylon, composite, and aluminum.

10. The system of claim 3 wherein the container comprise one or more materials selected from the group consisting of mesh, micro fiber terry cloth, and nylon ripstop.

11. The system of claim 1 wherein the system can be secured to the roof of a motor vehicle.

12. The system of claim 11, wherein the system is secured to the roof a motor vehicle by an attachment system comprising a strap, a buckle and a harness.

13. The system of claim 12 wherein the harness is comprised of nylon webbing, polypropylene webbing, plastic, aluminum, or composite.

14. The system of claim 2 wherein the container has an opening for a strap that tunnels the width of the container.

15. The system of claim wherein the opening for a strap comprises a strap that can be attached to the roof of a motor vehicle.

16. The system of claim 1 wherein the container has a container opening for accessing the inside of the container.

17. The system of claim 1 wherein the material object is a watersport garment with sleeves, wherein the watersport garment can hang from the hanger arms.

18. The system of claim 1 wherein air can flow through the hanger arms and into the sleeves of the watersport garment.

19. A method of exsiccating a material object using the system of claim 1 comprising:
attaching the material object to the system
attaching the system to a roof of a motor vehicle
moving the motor vehicle,
wherein upon moving the motor vehicle, air flows through the ventilation device into the container to exsiccate the material object.
